(19) United States
(12) Patent Application Publication
(10) Pub. No.: US 2014/0028160 A1
(43) Pub. Date: Jan. 30, 2014

(54) ROTARY ELECTRIC MACHINE AND CONTROLLER FOR SUCH AN ELECTRIC MACHINE

(71) Applicants: Eiji Yamada, Owariasahi-shi (JP); Ryoji Mizutani, Nagoya-shi (JP); Kenji Hiramoto, Owariasahi-shi (JP); Hideo Nakai, Nisshin-shi (JP); Norimoto Minoshima, Kariya-shi (JP)

(72) Inventors: Eiji Yamada, Owariasahi-shi (JP); Ryoji Mizutani, Nagoya-shi (JP); Kenji Hiramoto, Owariasahi-shi (JP); Hideo Nakai, Nisshin-shi (JP); Norimoto Minoshima, Kariya-shi (JP)

(73) Assignee: TOYOTA JIDOSHA KABUSHIKI KAISHA, Toyota-shi, Aichi-ken (JP)

(21) Appl. No.: 14/009,887

(22) PCT Filed: Apr. 4, 2012
(86) PCT No.: PCT/IB2012/000678

§ 371 Date: Oct. 4, 2013

(30) Foreign Application Priority Data
Apr. 7, 2011 (JP) 2011-085640

(51) Int. Cl. H02K 1/22

(52) U.S. Cl. CPC H02K 1/22
USPC 310/68 B; 310/184; 310/68 D

(57) ABSTRACT

A stator has a stator core, and stator windings wound around either the stator core or teeth of the stator. A rotor has a rotor core, windings wound around either the rotor core or teeth of the rotor, and magnetic auxiliary poles disposed between the teeth adjacent in a circumferential direction. The rotor further has diodes that are magnetic characteristic adjustment portions that cause the magnetic characteristic that occurs in the teeth by induced electromotive force produced in the rotor windings to vary in the circumferential direction of the rotor core.

### BACKGROUND OF THE INVENTION

1. Field of the Invention

The invention relates to a rotary electric machine in which a rotor and a stator are disposed so as to face each other, and to a rotary electric machine drive system.

2. Description of Related Art

As described in Japanese Patent Application Publication No. 2009-112091 (JP 2009-112091 A), there has been available a rotary electric machine in which a rotor is provided with rotor windings, and current is induced through the rotor windings by a rotating magnetic that is produced by a stator and that includes spatial harmonics, so that torque is produced in the rotor. The rotary electric machine described in JP 2009-112091 A is equipped with the stator and the rotor disposed radially inwardly of the stator. The stator has teeth that are provided at a plurality of locations on a stator core that are spaced from each other in a circumferential direction of the rotor. Around the teeth of the stator, stator windings of a plurality of phases are wound by a concentrated winding method. By passing alternating electric currents of a plurality of phases through the stator windings of the plurality of phases, a rotating magnetic field that rotates in a circumferential direction can be produced.

Besides, the rotor has salient poles provided at a plurality of locations on a rotor core that are spaced from each other in the circumferential direction of the rotor. A rotor winding is wound around each salient pole. The rotor windings are electrically separated from each other. A diode is connected to each one of the separate rotor windings. The diodes connected to two rotor windings that are adjacent to each other in the circumferential direction of the rotor are connected to their respective rotor windings in directions that are opposite to each other, so that the directions of the currents that flow through two adjacent rotor windings are opposite to each other. Due to this, when direct electric current flows through each rotor winding in the rectification direction of the diode, the magnetic directions of two salient poles adjacent to each other in the circumferential direction are opposite to each other, and therefore a magnet is formed in each salient pole so that N and S poles alternate with each other in the circumferential direction of the rotor.

In such a rotary electric machine, the salient poles are attracted to the rotating magnetic field of the stator so that reluctance torque acts on the rotor. Besides, due to spatial harmonic components of the rotating magnetic field of the stator, magnetic flux variation having a frequency different from that of a fundamental component of the rotating magnetic field occurs. Due to this magnetic flux variation, induced electromotive force is produced in the rotor windings, and the magnetic fields created at the salient poles by the induced electromotive force interact with the rotating magnetic field of the stator, so that a torque that corresponds to a magnet torque can be caused to act on the rotor. Therefore, the rotor is driven to rotate synchronously with the rotating magnetic field. Incidentally, besides Japanese Patent Application Publication No. 2009-112091 (JP 2009-112091 A), the related-art documents relevant to the invention also include Japanese Patent Application Publication No. 2007-185082 (JP 2007-185082 A), Japanese Patent Application Publication No. 2010-98908 (JP 2010-98908 A), Japanese Patent Application Publication No. 2010-110079 (JP 2010-110079 A), Japanese Patent Application Publication No. 2004-187488 (JP 2004-187488 A), and Japanese Patent Application Publication No. 2009-183060 (JP 2009-183060 A).

### SUMMARY OF THE INVENTION

The invention provides a rotary electric machine capable of effectively increasing the torque, and a rotary electric machine drive system equipped with the rotary electric machine.

A rotary electric machine in accordance with a first aspect of the invention is a rotary electric machine in which a stator and a rotor are disposed so as to face each other, and which is characterized in that the stator includes: a stator core; stator teeth disposed at a plurality of locations on the stator core that are spaced from each other in a circumferential direction of the stator; and a plurality of stator windings wound around at least one of the stator core and the stator teeth, and that the rotor includes: a rotor core; rotor teeth disposed at a plurality of locations on the rotor core that are spaced from each other in a circumferential direction of the rotor; a plurality of rotor windings wound around at least one of the rotor core and the rotor teeth; a magnetic auxiliary pole disposed between adjacent two of the rotor teeth that are adjacent to each other in the circumferential direction of the rotor; and a magnetic characteristic adjustment portion that causes a magnetic characteristic that occurs inside the rotor windings or the plurality of rotor teeth by induced electromotive force produced in the rotor windings to vary in the circumferential direction of the rotor core.

According to the above-described rotary electric machine in accordance with the first aspect of the invention, since the magnetic auxiliary pole is disposed between rotor teeth adjacent to each other in the circumferential direction, spatial harmonics and, particularly, spatial second harmonics of the magnetic field generated by the stator and that link with the rotor windings can be increased by the auxiliary pole, and changes in the magnetic flux can be increased, and the currents induced through the rotor windings can be increased. This results in an increased rotor magnetic force, so that the torque can be effectively increased in much of the operation region.

In the foregoing rotary electric machine in accordance with the first aspect of the invention, the auxiliary pole may be protruded from the rotor core toward the stator, and the auxiliary pole may include a distal end portion that is magnetic and a base portion that is nonmagnetic.

According to this construction, the magnetic flux that passes through an interior of the rotor core from the rotor teeth of the rotor that become S poles to the rotor teeth that become N poles can be prevented from being short-circuited by the base portion of any auxiliary pole, and the magnetic flux that should pass through the teeth in order to produce magnetic attraction forces between the rotor and the stator can be effectively prevented from decreasing. Therefore, increase of the self-inductance of the rotor windings can be restrained, so that the induced currents created through the rotor windings can be further increased, and the torque of the rotary electric machine can be further increased.

Besides, in the foregoing rotary electric machine in accordance with the first aspect of the invention, the auxiliary pole may be protruded from an outer circumferential surface of the rotor core toward the stator, and the auxiliary pole may include a base portion and a distal end portion that has a thickness in the circumferential direction of the rotor that is larger than a thickness of the base portion in the circumferential direction of the rotor. In this construction, for example, the whole of the auxiliary pole may be formed of a magnetic material, or the base portion of the auxiliary pole and the distal end portion thereof may be formed of a non-magnetic material and a magnetic material, respectively.

According to the foregoing construction, by lessening the thickness of the base portion of the auxiliary pole in the circumferential direction, it is possible to cause the magnetic flux that passes through, the base portion to saturate. Therefore, the magnetic flux that passes through an interior of the rotor from the rotor teeth of the rotor that become S poles to the rotor teeth that become N poles can be prevented from being short-circuited by the base portion of the auxiliary pole. Therefore, the magnetic flux that should pass through the teeth in order to produce magnetic attraction forces between the rotor and the stator can be effectively prevented from decreasing. Hence, since increase of the self-inductance of the rotor windings can be restrained, the induced currents that occur in the rotor windings can be increased, and the torque can be increased.

Furthermore, in the rotary electric machine in accordance with the first aspect of the invention, the base portion and the distal end portion may be joined via a stepped portion.

Furthermore, in the rotary electric machine in accordance with the first aspect of the invention, the rotor windings may be connected to rectifying elements, each of which is the magnetic characteristic adjustment portion, in such a manner that forward directions of the rectifying elements in two of the rotor windings that are adjacent to each other in the circumferential direction of the rotor are opposite to each other, and the rectifying elements may be configured so as to cause phases of electric currents that flow through the rotor windings adjacent to each other in the circumferential direction to be different from each other so as to alternate between an A-phase and a B-phase, by rectifying currents that flow through the rotor windings due to production of the induced electromotive force.

Furthermore, in the rotary electric machine in accordance with the first aspect of the invention, a width of each of the rotor windings in the circumferential direction of the rotor may be less than the width that corresponds to 180° in electrical angle.

Furthermore, in the rotary electric machine in accordance with the first aspect of the invention, the width of each of the rotor windings in the circumferential direction of the rotor may be equal to the width that corresponds to 90° in the electrical angle.

A rotary electric machine drive system in accordance with a second aspect of the invention is a rotary electric machine drive system characterized by including: the rotary electric machine in accordance with, the first aspect of the invention; a drive portion that drives the rotary electric machine; and a control portion that controls the drive portion, wherein the control portion includes a decreasing pulse superimposition means for superimposing a decreasing pulse current that has a decrease in a pulse fashion on a q-axis current command for causing current to flow through the stator windings so as to produce field magnetic fluxes in directions that are advanced 90° in the electrical angle from magnetic pole directions that are the directions of winding center axes of the rotor windings. Incidentally, the aforementioned decreasing pulse current means a pulse current that sharply decreases and then sharply increases in a pulse fashion (which applies to the entire specification and the claims). Besides, the pulse waveform of the decreasing pulse current may be any waveform, including rectangular waves, triangular waves, or waves formed into a prominent shape from a plurality of curves and straight lines.

According to the rotary electric machine drive system of the second aspect of the invention, it is possible to realize a rotary electric machine that is capable of increasing the torque over much of the region and further increasing the torque in a low-rotation speed region while preventing excessively large currents from flowing through the stator windings. For example, in the case where the stator windings of a plurality of phases are stator windings of three phases, even when the absolute value of current through the stator winding of one phase (e.g., the W-phase) is higher than the absolute values of the currents that flow through the stator windings of the other phases (e.g., the U-phase and the V-phase) before the superimposition of the pulse current is performed for the stator winding of the one phase (e.g., the W-phase), the superimposition of the decreasing pulse current increases the induced current produced in the rotor windings while lowering the absolute values of the currents that flow through the windings of all the phases in a pulse fashion. Therefore, it is possible to increase the torque of the rotary electric machine even in a low-rotation speed region while restraining the peaks of the stator currents that are the currents passed through all the stator windings. In addition, it is possible to increase the spatial harmonics and, particularly, the spatial second harmonics of the rotating magnetic field generated by the stator and that link with the rotor windings through the use of the auxiliary pole, so that the change in the magnetic flux can be enlarged, and the current induced through the rotor windings can be increased, and the torque of the rotary electric machine in a low-rotation speed region can be increased.

A rotary electric machine drive system in accordance with a third aspect of the invention is a rotary electric machine drive system characterized by including: the rotary electric machine in accordance with the first aspect of the invention; a drive portion that drives the rotary electric machine; and a control portion that controls the drive portion, wherein the control portion includes a decreasing/increasing pulse superimposition device which superimposes a decreasing pulse current that has a decrease in a pulse fashion on a q-axis current command for causing current to flow through the stator windings so as to produce field magnetic fluxes in directions that are advanced 90° in the electrical angle from magnetic pole directions that are the directions of winding center axes of the rotor windings, and which superimposes an increase pulse current that has an increase in the pulse fashion on a d-axis current command for causing current to flow through the stator windings so as to produce field magnetic fluxes in the magnetic pole directions. Incidentally, the aforementioned increasing pulse current means a pulse current that sharply increases then sharply decreases in a pulse fashion (which applies to the entire specification and the claims). Besides, the pulse waveform of the increasing pulse current may be any waveform, including rectangular waves, triangular waves, or waves formed into a prominent shape from a plurality of curves and straight lines.

According to the rotary electric machine drive system of the third aspect of the invention, it is possible to realize a rotary electric machine that is capable of increasing the torque over much of the region and further increasing the torque in a low-rotation speed region while preventing excessively large currents from flowing through the stator windings. That is, by superimposing the decreasing pulse current on the q-axis current command and the increasing pulse current on the d-axis current command, it is possible to enlarge the induced currents produced in the rotor windings while containing the currents of all the phases within the required current restriction range. Furthermore, since the increasing pulse current is superimposed on the d-axis current command, the amount of variation of the magnetic flux that is generated by the d-axis current command and that passes through the d-axis magnetic path can be enlarged. The passage through air gap can be made less in the d-axis magnetic path corresponding to the d-axis current command than in the q-axis magnetic path corresponding to the q-axis current command, so that the magnetic resistance lowers. Therefore, increasing the amount of variation of the d-axis magnetic flux is effective for increasing the torque. Therefore, it is possible to increase the current induced through the rotor windings and therefore the torque of the rotary electric machine even in a low-rotation speed region while restraining the peaks of the stator currents of all the phases. Besides, due to the auxiliary poles, it is possible to increase the spatial harmonics and, particularly, the spatial second harmonics of the rotating magnetic field generated by the stator and that link with the rotor windings, so that the change of the magnetic flux can be enlarged, and the current induced through the rotor windings can be increased, and the torque in a low-rotation speed region can be increased.

According to the rotary electric machine and the rotary electric machine drive system of the invention, it is possible to realize a rotary electric machine capable of effectively increasing the torque by causing a large amount of harmonic components of the rotating magnetic field to link with the rotor windings.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing a state in which diodes that are rectifying elements are coupled to rotor windings in a rotary electric machine in accordance with an embodiment of the invention;

FIG. 2 is a schematic sectional view showing a portion of the rotary electric machine of FIG. 1 which extends in a circumferential direction and in which a portion of a stator and a portion of a rotor face each other, while omitting illustrations of diodes;

FIG. 3 is an enlarged and detailed view of a portion A shown in FIG. 2;

FIG. 4 is a schematic diagram showing a manner in which a magnetic flux produced by induced currents flowing through rotor windings flows in the rotor in an embodiment of the invention;

FIG. 5 is a diagram showing results of calculating the amplitude (variation width) of the magnetic flux linkage with the rotor windings while changing the circumferential width θ of the rotor windings in the circumferential direction in the rotary electric machine shown in FIG. 1;

FIG. 6A is a diagram showing rotation speed-torque characteristics with different stator currents as results obtained from a simulation performed with a rotary electric machine of a comparative example that does not have any auxiliary poles;

FIG. 6B is a diagram showing relations between the rotor magnetomotive force and the rotation speed with different stator currents as results obtained from a simulation performed with the rotary electric machine of the comparative example;

FIG. 7A is a diagram showing rotation speed-torque characteristics with different stator currents as results obtained from a simulation performed with the rotary electric machine of the embodiment of the invention;

FIG. 7B is a diagram showing relations between the rotor magnetomotive force and the rotation speed with different stator currents as results obtained from a simulation performed with the rotary electric machine of the embodiment of the invention;

FIG. 8A is a diagram showing the spatial harmonic flux linkages of the rotor windings as results obtained from simulations performed with a comparative example that does not have any auxiliary poles and Examples 1 and 2;

FIG. 8B is a diagram showing the self-inductances of rotor windings as results of simulations performed with the comparative example and Examples 1 and 2;

FIG. 8C a diagram showing the rotor's induced currents through the rotor windings as results obtained from simulations performed with the comparative example and Examples 1 and 2;

FIG. 8D is a diagram showing the torques of rotary electric machines as results obtained from simulations performed with the comparative example and Examples 1 and 2;

FIG. 9A is a schematic diagram showing magnetic flux lines of spatial harmonics as results obtained from a simulation performed with a comparative example that does not have any auxiliary poles;

FIG. 9B is a schematic diagram showing magnetic flux lines of spatial harmonics as results obtained from a simulation performed with an embodiment of the invention;

FIG. 10A is a schematic diagram showing magnetic flux lines created by rotor's induced current as results obtained from a simulation performed with a comparative example that does not have any auxiliary poles;

FIG. 10B is a schematic diagram showing magnetic flux lines created by the rotor's induced current as results obtained from a simulation performed with Example 1 in which a base portion of each auxiliary pole is made of a magnetic material in the embodiment of the invention;

FIG. 10C is a schematic diagram showing magnetic flux lines created by the rotor's induced current as results obtained from a simulation performed with Example 2 in which a base portion of each auxiliary pole is made of a non-magnetic material in the embodiment of the invention;

FIG. 11 is a diagram showing a general construction of a rotary electric machine drive system in accordance with an embodiment of the invention;

FIG. 12 is a block diagram showing a construction of a control device in the embodiment of the invention;

FIG. 13A is a diagram showing an example of time-dependent changes in the stator current in the embodiment of the invention in terms of the d-axis current command value Id*, the post-superimposition q-axis current command value Iqsum*, and the electric currents of the three phases;

FIG. 13B is a diagram showing time-dependent changes in the rotor magnetomotive force corresponding to FIG. 13A;

FIG. 13C is a diagram showing time-dependent changes in the motor torque corresponding to FIG. 13A;

FIGS. 14A to 14C show schematic diagrams showing manners in which magnetic flux passes through the stator and the rotor in the embodiment of the invention, in the case (FIG. 14A) where the q-axis current is a constant value, an early period (FIG. 14B) of the case where the decreasing pulse current is superimposed on the q-axis current, and a late period (FIG. 14C) of the case where the decreasing pulse current is superimposed on the q-axis current;

FIG. 15 is a diagram showing examples of the current that is passed through the stator winding of the U-phase (stator current) and the induced current that occurs in a rotor winding (rotor's induced current) in a rotary electric machine drive system that superimposes the increasing pulse current on stator current;

FIGS. 16A and 16B show schematic diagrams of a rotor showing a change that occurs when the pulse current is superimposed on the q-axis current in a rotary electric machine in accordance with another embodiment of the invention;

FIG. 17 is a diagram showing a relation between the rotation speed and the torque of the rotary electric machine for illustrating an example in which the state of superimposition of the pulse current is changed in the embodiment of the invention;

FIG. 18 is a schematic diagram showing another example of a rotor of a rotary electric machine in accordance with an embodiment of the invention;

FIG. 19 is a schematic diagram showing still another example of a rotor of a rotary electric machine in accordance with an embodiment of the invention; and

FIG. 20 is a schematic diagram showing yet another example of a rotor of a rotary electric machine in accordance with an embodiment of the invention; and

FIG. 21 is a schematic diagram showing a further example of a rotor of a rotary electric machine in accordance with an embodiment of the invention.

### DETAILED DESCRIPTION OF EMBODIMENTS

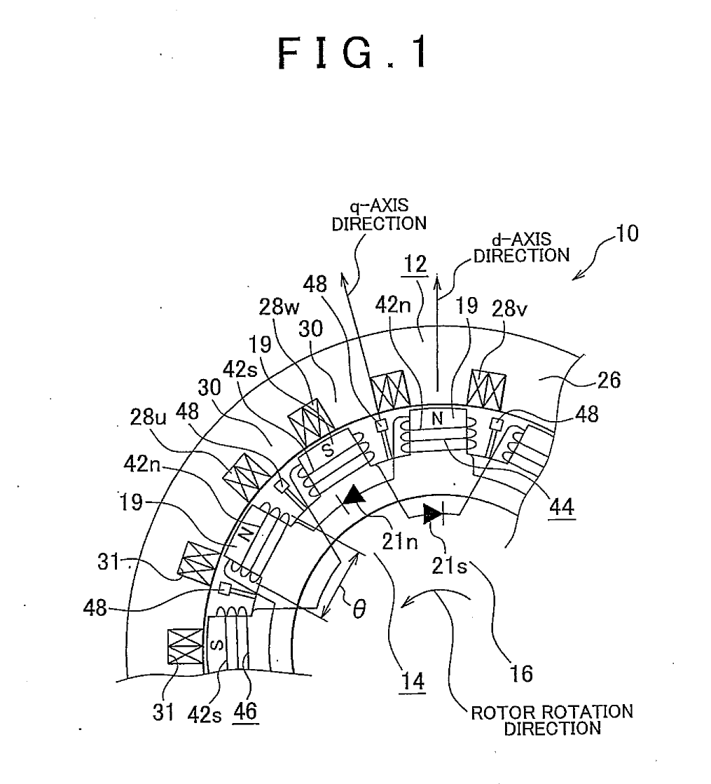

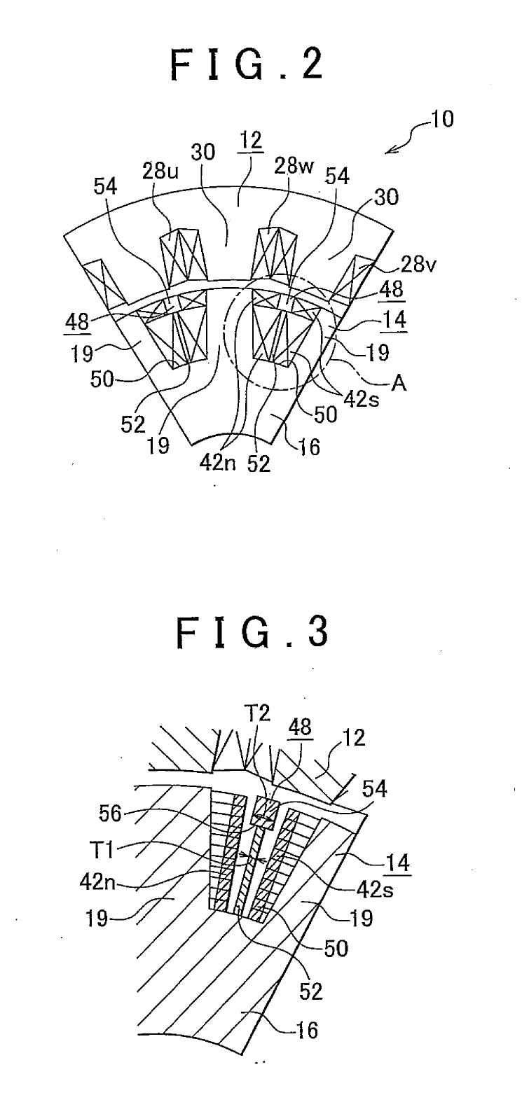

Embodiments of the invention will be described hereinafter with reference to the drawings. FIGS. 1 to 3 are diagrams showing an embodiment of the invention. FIG. 1 is a schematic diagram showing a state in which diodes that are rectifying elements are coupled to rotor windings in a rotary electric machine in accordance with the embodiment of the invention. FIG. 2 is a schematic sectional view showing a portion of the rotary electric machine of FIG. 1 which extends in a circumferential direction and in which a portion of a stator and a portion of a rotor face each other, while omitting illustrations of diodes. FIG. 3 is an enlarged and detailed view of a portion A shown in FIG. 2. As shown in FIG. 1, a rotary electric machine 10 that functions as an electric motor or an electricity generator includes a stator 12 that is fixed to a casing (not shown), and a rotor 14 that is disposed inwardly of the stator 12 in radial directions so as to face the stator 12 with a predetermined air gap left therebetween and that is rotatable relative to the stator 12 (the term “radial direction” (that is sometimes indicated by the term radial) refers to any radial direction orthogonal to the rotation center axis of the rotor 14, and hereinafter the meaning of the “radial direction” is the same in the following description unless otherwise indicated).

Besides, the stator 12 includes a stator core 26, teeth 30 disposed at a plurality of locations on the stator core 26 in a circumferential direction thereof, and stator windings 28u, 28v, and 28w of a plurality of phases (more concretely, three phases, that is, a u-phase, a v-phase, and a w-phase) that are disposed around the individual teeth 30, that is, wound around them. Specifically, on an inner circumferential surface of the stator core 26, the teeth 30 that are a plurality of stator teeth protruded radially inward (toward the rotor 14) are disposed spaced from each other in the direction of a circumference about the rotation center axis of the rotor 14 and therefore slots 31 are formed between the individual teeth 30 (incidentally, the “circumferential direction” refers to any direction along a circle drawn with its center on the rotation center axis of the rotor, and the meaning of the term “circumferential direction” is the same in the following description unless otherwise indicated). The stator core 26 and the teeth 30 are formed as an integral body from a magnetic material.

The stator windings 28u, 28v, and 28w of the phases are wound around the individual teeth 30 by passing the wires through the slots 31 by a short-pitch concentrated winding method. Due to the stator windings 28u, 28v, and 28w being wound on the teeth 30 in the foregoing manner, the magnetic poles are constructed. Then, by passing alternating electric currents of plural phases through the stator windings 28u, 28v, and 28w of plural phases, the teeth 30 juxtaposed in the circumferential direction become magnetized, so that the stator 12 produces a rotating magnetic field that rotates in the circumferential direction. Incidentally, the stator windings are not limited to a construction in which windings are wound around the stator teeth, but can also be wound on the stator core apart from the stator teeth.

The rotating magnetic field formed by the teeth 30 and extending from the distal end surfaces thereof acts on the rotor 14. In the example shown in FIG. 1, three teeth 30 around which the three stator windings 28u, 28v, and 28w of the three phases (the u-phase, the v-phase and the w-phase) are wound constitute a pair of poles.

The rotor 14 includes: a hollow cylindrical rotor core 16; teeth 19 that are projections protruded radially outward (toward the stator 12) from a plurality of locations on an outer circumferential surface of the rotor core 16 in the circumferential direction thereof, and that are main salient poles, i.e., rotor teeth; and a plurality of rotor windings 42n and 42s. The rotor core 16 and the teeth 19 are formed as an integral body of a magnetic material. More specifically, a plurality of first rotor windings 42n are wound, by the concentrated winding method, around every other teeth 19 in the circumferential direction of the rotor 14, and a plurality of second rotor windings 42s are wound, by the concentrated winding method, around the teeth 19 that are adjacent to the aforementioned teeth 19 provided with the first rotor windings 42n and that are the other set of every other teeth 19 in the circumferential direction. Besides, a first rotor winding circuit 44 that includes the plurality of first rotor windings 42n and a second rotor winding circuit 46 that includes the plurality of second rotor windings 42s are connected with a diode 21n and a diode 21s, respectively, each of which is a magnetic characteristic adjustment portion and is a rectifying element. That is, the first rotor windings 42n and the second rotor windings 42s are wound at a plurality of locations on the rotor core 16 in the circumferential direction by the concentrated winding method. Besides, the first rotor windings 42n disposed at every other site in the circumferential direction of the rotor 14 are electrically connected in series and in an endless (or loop) fashion, and the diode 21n, which is a rectifying element and a first diode, is inserted in and connected in series to a portion of the series connected circuit of the first rotor windings 42n. In this manner, the first rotor winding circuit 44 is constructed. All the first rotor windings 42n are wound around the teeth 19 that function as the same magnetic pole (N pole).

Besides, the second rotor windings 42s are electrically connected in series and in an endless (or loop) fashion, and the diode 21s, which is a rectifying element and is a second diode, is connected in series to a portion of the series connected circuit of the second rotor windings 42s. In this manner, the second rotor winding circuit 46 is constructed. All the second rotor windings 42s are wound around the teeth 19 that function as the same magnetic pole (S pole). Besides, the rotor windings 42n and 42s wound around two teeth 19 adjacent to each other in the circumferential direction (which form magnets of opposite poles) are electrically separated from each other.

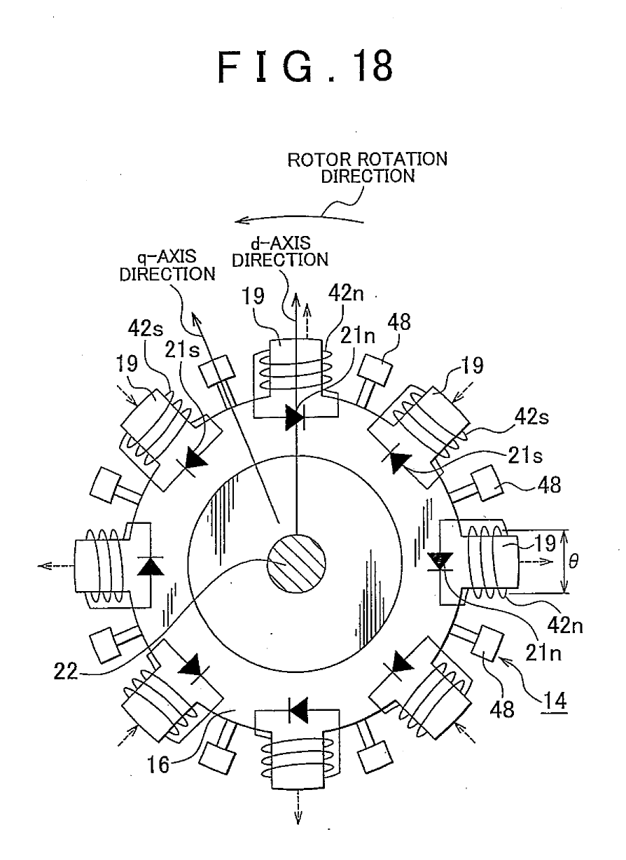

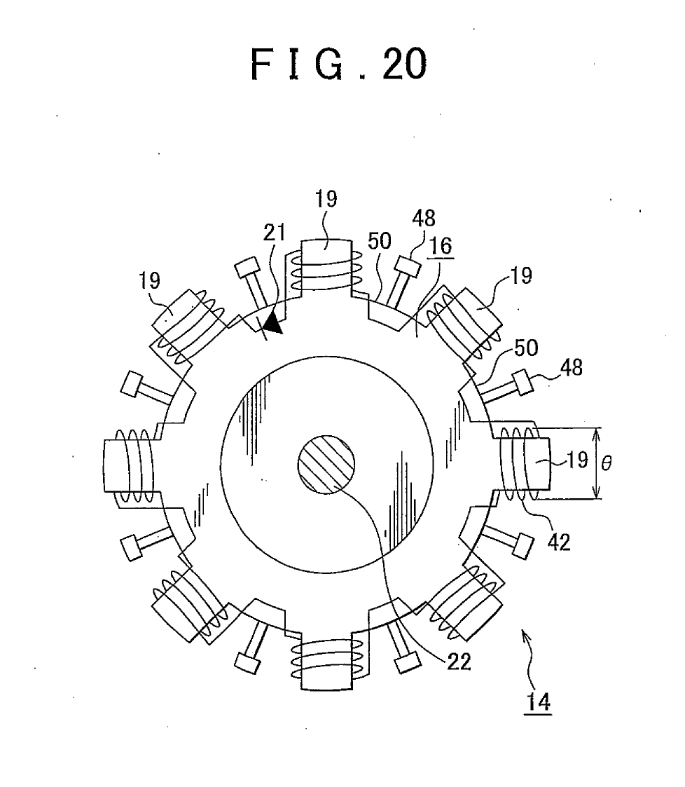

Besides, the rectification directions of current of the rotor windings 42n and 42s achieved by the diodes 21n and 21s are opposite to each other so that two teeth 19 adjacent to each other in the circumferential direction of the rotor 14 form magnets of opposite magnetic poles. That is, the diode 21n and the diode 21s are mutually inversely connected to the rotor windings 42n and the rotor windings 42s that alternate with each other in the circumferential direction in such a manner of connection that the direction, in which current flows through the rotor windings 42n, and the direction, in which current flows through the rotor windings 42s (i.e., the directions of rectification by the diodes 21n and 21s), that is, the forward directions of the diodes 21n and 21s, are opposite to each other. Besides, the winding center axis of each of the rotor windings 42n and 42s lies in a radial direction. Then, the diodes 21n and 21s rectify the currents caused to flow through the rotor windings 42n and 42s, respectively, by the electromagnetic forces induced by the rotating magnetic field that is produced by the stator 12 and that includes spatial harmonics, so that the phases of the currents that flow through two rotor windings 42n and 42s adjacent to each other in the circumferential direction of the rotor 14 are made to be an A-phase and a B-phase that alternate with each other. The A-phase current produces an N pole in the distal end side of each of the corresponding teeth 19, and the B-phase current produces an S pole in the distal end side of each of the corresponding teeth 19. That is, the rectifying elements provided for the rotor 14 are the diode 21n and the diode 21s, which are the first rectifying element and the second rectifying element connected to the rotor windings 42n and the rotor windings 42s, respectively. Besides, the diodes 21n and 21s each independently rectify the currents that are induced to flow through the rotor windings 42n and 42s, respectively, by the induced electromotive forces, so that the magnetic characteristics of the teeth 19, disposed at a plurality of locations in the circumferential direction, that are determined by the currents that flow through the rotor windings 42n and through the rotor windings 42s vary alternately in the circumferential direction. Thus, the plurality of diodes 21n and 21s cause the magnetic characteristics of the plurality of teeth 19 attributed to the induced electromotive forces produced in the rotor windings 42n and 42s to vary alternately in the circumferential direction. In this construction, the number of the diodes 21n and 21s can be reduced to two, and therefore the structure of the windings of the rotor 14 can be simplified; unlike another embodiment described below with reference to FIG. 18. Besides; the rotor 14 is fixed concentrically to a radially outer side of a rotary shaft 22 (see FIGS. 18 and 20, etc. since FIG. 1 does not show the rotary shaft 22) that is rotatably supported on a casing (not shown). Incidentally, each of the rotor windings 42n and 42s may be wound around a corresponding one of the teeth 19, with an insulator or the like that is made of resin or the like and has electrical insulation property interposed between each of the rotor windings 42n and 42s and the corresponding one of the teeth 19.

Besides, the width θ of each of the rotor windings 42n and 42s in the circumferential direction of the rotor 14 is set smaller than the width that corresponds to 180° in the electrical angle of the rotor 14, and the rotor windings 42n and 42s are wound around the teeth 19 by a short-pitch winding method. More preferably, the width θ of the rotor windings 42n and 42s in the circumferential direction of the rotor 14 is set equal or substantially equal to the width that corresponds to 90° in the electrical angle of the rotor 14. The width θ of the rotor windings 42n and 42s herein can be represented by a center width of a cross-section of the rotor windings 42n and 42s, taking the cross-sectional area of the rotor windings 42n and 42s into account. That is, the width θ of the rotor windings 42n and 42s can be represented by an average value of the interval between inner circumferential surfaces of each of the rotor windings 42n and 42s in the circumferential direction and the interval between outer circumferential surfaces thereof in the circumferential direction. Incidentally, the electrical angle of the rotor 14 is represented by the multiplication product of the mechanical angle of the rotor 14 by the number p of the pairs of poles of the rotor 14 (electrical angle=mechanical angle×p). Therefore, the width θ of each, of the rotor windings 42n and 42s in the circumferential direction satisfies, the following expression (1), where r is the distance from the rotation center axis of the rotor 14 to the rotor windings 42n and 42s.

θ<π×r/p (1)

The reason why the width θ is restricted in this manner will be explained in detail later.

Particularly, in this embodiment, the rotor core 16 includes a plurality of auxiliary poles 48, each disposed at a position between two teeth 19 adjacent to each other in the circumferential direction of the rotor 14, such as a center position between two teeth 19 adjacent to each other in the circumferential direction. Each auxiliary pole 48 is magnetic due to at least a portion being made of a magnetic material. For example, as shown in FIG. 2 and FIG. 3, each auxiliary pole 48 is provided on a circumferentially central portion of the bottom of a slot 50 that is a groove portion formed between two circumferentially adjacent teeth 19 on an outer circumferential surface of the rotor core 16 in such a manner that the auxiliary poles 48 are protruded radially outward, that is, toward the stator 12. Each auxiliary pole 48 has a base portion 52 that is formed of a non-magnetic material, and a distal end portion 54 that is joined to a distal end side of the base portion 52 and that is formed of a magnetic material. A base end of the base portion 52 which is an inner end in the radial direction of the rotor 14 is integrally joined and fixed to the outer circumferential surface of the rotor core 16. Thus, the plurality of auxiliary poles 48 are provided so as to be protruded from the outer circumferential surface of the rotor core 16 toward the stator 12, and are each constructed of the magnetic distal end portion 54 and the nonmagnetic base portion 52. Besides, each of the base portion 52 and the distal end portion 54 has a generally rectangular sectional shape in a section in the circumferential direction. However, the shapes of the base portion 52 and the distal end portion 54 are not limited to this example.

Besides, as shown in FIG. 3, a thickness T1 of the base portion 52 in the circumferential direction is made smaller than a thickness T2 of the distal end portion 54 in the circumferential direction (T1<T2), and therefore a stepped portion 56 is provided at a coupling portion between the distal end portion 54 and the base portion 52. The stepped portion 56 faces inward in the radial direction of the rotor 14. The base portion 52 is joined to a circumferentially central portion of a radially inward facing surface of the stepped portion 56 of the distal end portion 54. That is, the distal end portion 54 and the base portion 52 are joined via the stepped portion 56. Incidentally, although in the example shown in FIG. 3, the rotor windings 42s and 42n are formed by square wires or flat rectangular wires that have a rectangular sectional shape, this is not restrictive. For example, the rotor windings 42s and 42n can also be formed by round wires that have a circular sectional shape. Besides, the distal end portion 54 can be formed of the same material as the material of the rotor core 16, for example, a magnetic steel sheet, a magnetic material such as steel or the like. In contrast, the base portion 52 is formed of a non-magnetic material such as resin, a non-magnetic metal, including stainless steel and the like, etc.

Incidentally, the auxiliary poles 48 can also be formed by demagnetizing the base portion 52 of each auxiliary pole 48 when the auxiliary poles 48 are formed integrally with the rotor core 16 made of a magnetic material. For example, after the auxiliary poles 48 and the rotor core 16 equipped with the teeth 19 are integrally formed, the base portion 52 of each auxiliary pole 48 can be demagnetized by a laser irradiation process that is performed while nickel is being supplied. Besides, each auxiliary pole 48 can be constructed by coupling a non-magnetic material portion made of stainless steel or the like to a distal end-side magnetic material portion, and the thus-formed auxiliary poles 48 can be joined to portions of a separate rotor core 16 by welding or the like. Besides, the base portions 52 made of a non-magnetic material, such as resin or the like, can be manufactured separately from the teeth 19 and the distal end portions 54, and can be mechanically joined to portions of a separate rotor core 16 and distal end portions 54 via engagement portions and the like. For example, it is also possible to provide a construction in which a base end portion of the base portion 52 of each auxiliary pole 48 is provided with an enlarged portion whose sectional area is sharply increased from the sectional areas of adjacent portions, and in which hole portions are formed in portions of the outer circumferential surface of the rotor core 16 to which the base end portions 52 are joined, and in which an engagement portion capable of engaging with the enlarged portion of an auxiliary pole 48 is formed in a deep inside portion of each hole portion, and then to couple the base portion 52 of each auxiliary pole 48 to the rotor core 16 by inserting the enlarged portion of each auxiliary pole 48 into one of the hole portions while elastically deforming the enlarged portion so that the enlarged portion is engaged with the engagement portion of the hole portion. Furthermore, in a similar construction, it is also possible to mechanically couple the distal end portion 54 of each auxiliary pole 48 to an enlarged portion that is formed on the base portion 52 thereof.

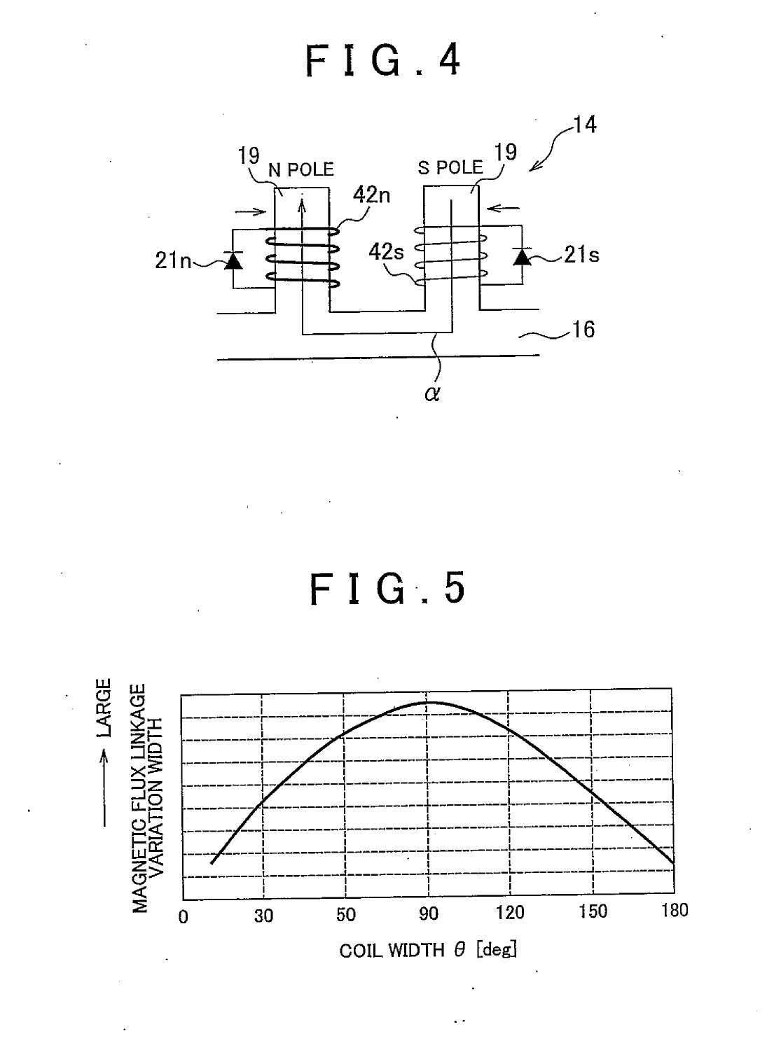

Besides, on the rotor 14 side, as shown in a schematic illustration in FIG. 4, diodes 21n and 21s are connected to rotor windings 42n and 42s, respectively, that are wound around teeth 19 adjacent to each other in the circumferential direction of the rotor 14. As the rotating magnetic field having harmonics which is produced by the stator 12 (FIGS. 1 and 2) links with the rotor windings 42n and 42s, currents are induced through the rotor windings 42n and 42s while the directions of the currents are restricted by the diodes 21n and 21s, respectively, so that the teeth 19 are magnetized so that two adjacent teeth 12 become mutually different magnetic pole portions. In this case, the magnetic flux produced by the induced currents flows in the teeth 19 and the rotor core 16 in a course as shown by an arrow α in FIG. 4.

Referring back to FIG. 1, the rotary electric machine 10 in this embodiment is constructed of the rotor 14 and the stator 12 that is disposed radially outwardly of the rotor 14 so as to face the rotor 14. According to the thus-constructed rotary electric machine 10, it is possible to induce currents through the rotor windings 42n and 42s by the rotating magnetic field that has spatial harmonics and that is produced by the stator 12 and therefore to produce torque on the rotor 14. Specifically, the distribution of the magnetomotive force that produces the rotating magnetic field around the stator 12 is not a sinusoidal distribution (containing only the fundamental component), but is a distribution that contains harmonic components, due to the arrangement of the stator windings 28u, 28v, and 28w of the three phases, and the shape of the stator core 26 that depends on the teeth 30 and the slots 31. In particular, in the concentrated winding method, the stator windings 28u, 28v, and 28w of the three phases do not overlap with each other, so that the amplitude level of the harmonic components that occur in the magnetomotive force distribution in the stator 12 increases. For example, in the case where the stator windings 28u, 28v, and 28w are formed by the three-phase concentrated winding method, the spatial second-order component that is the (temporal) third-order component of the input electric frequency increases in amplitude level. The harmonic components that occur in the magnetomotive force due to the arrangement of the stator windings 28u, 28v, and 28w and the shape of the stator core 26 is termed the spatial harmonic.

Besides, as the rotating magnetic field (fundamental component) formed around the teeth 30 of the stator 12 by passing three-phase alternating electric current through the three-phase stator windings 28u, 28v, and 28w acts on the rotor 14, the teeth 19 of the rotor 14 are attracted by the rotating magnetic field so that the magnetic resistance of the rotor 14 lessens. Due to this, torque (reluctance torque) acts on the rotor 14.

Furthermore, when the rotating magnetic field having spatial harmonic components which is formed around the teeth 30 links with the rotor windings 42n and 42s of the rotor 14, magnetic flux variation of a frequency different from the rotation frequency of the rotor 14 (the fundamental component of the rotating magnetic field) is caused in the rotor windings 42n and 42s by the spatial harmonic components. Due to this magnetic flux variation, induced electromotive force is produced in the rotor windings 42n and 42s. The currents that flow through the rotor windings 42n and 42s due to the production of the induced electromotive force are rectified into one direction (into direct current) by the diodes 21n and 21s, respectively. Then, when the teeth 19, that is, the rotor teeth, are magnetized as the direct electric currents rectified by the diodes 21n and 21s flow through the rotor windings 42n and 42s, respectively, the teeth 19 function as magnets whose magnetic poles are fixed (to either the N pole or the S pole). Since the rectification directions of the currents through the rotor windings 42n and 42s by the diodes 21n and 21s are opposite to each other as described above, magnets are formed in the teeth 19 so that N poles and S poles alternate with each other in the circumferential direction. The magnetic fields of the teeth 19 (the magnets with fixed poles) interact with the rotating magnetic field (fundamental component) produced by the stator 12, so that attracting and repelling actions occur. The electromagnetic interaction (attracting and repelling actions) between the rotating magnetic field (fundamental component) generated by the stator 12 and the magnetic fields of the teeth 19 (magnets) can also cause a torque (torque corresponding to the magnet torque) to act on the rotor 14, and the rotor 14 is rotated synchronously with the rotating magnetic field (fundamental component) generated by the stator 12. Thus, the rotary electric machine 10 can be caused to function as an electric motor that produces motive power (mechanical power) by using the electric power supplied to the stator windings 28u, 28v, and 28w.

Furthermore, according to the rotary electric machine 10 of this embodiment, there are provided the auxiliary poles 48 that are provided between teeth 19 of the rotor 14 and a portion of each auxiliary pole 48 is formed of a non-magnetic material. Therefore, the spatial harmonics, in particular, the spatial second harmonic of the rotating magnetic field generated by the stator 12, that links with the rotor windings 42n and 42s, can be increased by the auxiliary poles 48, and changes in the magnetic flux can be increased, and the currents induced in the rotor windings 42n, and 42s can be increased. As a result, the rotor magnetic force can be increased, and the torque can be effectively increased in large extents of regions, for example, substantially the entire operation region, or the like.

Besides, the auxiliary poles 48 are joined to the outer circumferential surface of the rotor core 16 between two teeth 19 adjacent to each other in the circumferential direction of the rotor 14 so as to be projected toward the stator 12, and has a base portion 52 formed of a non-magnetic material, and a distal end portion 54 formed of a magnetic material. Therefore, the magnetic flux that passes through an interior of the rotor core 16 from the teeth 19 of the rotor 14 that become S poles to the teeth 19 that become N poles can be prevented from being short-circuited by the base portion 52 of any auxiliary pole 48, and the magnetic flux that passes through the teeth 19 in order to produce magnetic attraction forces between the rotor 14 and the stator 12 can be effectively prevented from decreasing. Therefore, increase of the self-inductance of the rotor windings 42n and 42s can be restrained, so that the induced currents created through the rotor windings 42n and 42s can be further increased, and the torque of the rotary electric machine 10 can be further increased.

Besides, each auxiliary pole 48 has the base portion 52 and the distal end portion 54 which is joined to the base portion 52 and whose circumferential thickness T2 is larger than the corresponding thickness of the base portion 52. Therefore, by lessening the thickness T1 of the base portion 52 in the circumferential direction, the magnetic flux that passes through the base portion 52 can be brought to a saturation state. Therefore, this also effectively prevents the magnetic flux that should pass through the teeth 19 in order to produce magnetic attraction forces between the rotor 14 and the stator 12, from decreasing, and restrains increase of the self-inductance of the rotor windings 42n and 42s. Therefore, the induced currents that occur in the rotor windings 42n and 42s can be increased, and the torque of the rotary electric machine 10 can be increased.

In contrast, in the rotary electric machine described in JP 2010-279165 A mentioned above, no auxiliary pole is provided between adjacent salient poles that correspond to rotor teeth that are provided with rotor windings and that are adjacent to each other in the circumferential direction of the rotor, and therefore there is room for improvement in terms of effective enhancement of torque. That is, in the rotary electric machine described in JP 2010-279165 A, too, torque is produced by the induced current produced through the rotor windings by variations of the magnetic field that are caused by the harmonic component of the rotating magnetic field generated by the stator. However, the spatial harmonics pass, in a large amount, through high-magnetic resistance spaces between adjacent salient poles provided on the rotor, and therefore there is a possibility of failing to increase the magnetic flux. Therefore, there is room for improvement in terms of effective enhancement of the torque of the rotor.

Besides, JP 2007-185082 A, JP 2010-98908 A and JP 2010-11079 A, which are mentioned above, each describe a field winding type synchronous machine that utilizes superposition of pulse currents, but do not disclose any means capable of effectively increasing torque by causing a large amount of spatial harmonics of the rotating magnetic field to link with the rotor windings.

Besides, JP 2004-187488 A mentioned above describes a rotary electric machine having a stator in which a plurality of main teeth are provided on an inner circumferential surface of a stator core, and auxiliary teeth are provided in slot portions between adjacent main teeth, and when a coil is wound around each main teeth, an outer circumferential surface of the coil closely contacts the adjacent auxiliary teeth. Besides, JP 2009-183060 A mentioned above describes a rotary electric machine having a permanent magnet-equipped rotor in which the pitch of a winding pole in the circumferential direction of the stator is different from the pitch of another winding pole. However, it is to be noted that none of the structures described in JP 2004-187488 A and JP 2009-183060 A is a structure that effectively increases the torque by causing a large amount of the spatial harmonics of the rotating Magnetic field to link with the rotor winding. In the structures described in JP 2007-185082 A, JP 2010-98908 A, JP 2010-11079 A, JP 2004-187488 A and JP 2009-183060 A, if the core thickness of the rotary electric machine is increased in order to increase the torque, this will become a factor that increases the size of the rotary electric machine or brings about a cost increase and a weight increase. Besides, if the stator current is increased in order to increase the torque, this will also become a factor that increases the copper loss and therefore decreases the fuel economy, and that increases the size of the inverters, and that brings about a cost increase, a weight increase, or deterioration of mountability and cooling property. According to the rotary electric machine 10 of this embodiment, the foregoing inconveniences can all be solved.

Besides, in this embodiment, since the width θ of the rotor windings 42n and 42s in the circumferential direction of the rotor 14 is restricted as stated in the foregoing expression (1), the induced electromotive force produced in the rotor windings 42n and 42s by the spatial harmonics of the rotating magnetic field is increased. Specifically, the amplitude (variation width) of the magnetic flux linking with the rotor windings-42n and 42s due to the spatial harmonics is affected by the width θ of the rotor windings 42n and 42s in the circumferential direction. FIG. 5 shows results of calculating the amplitude (variation width) of the magnetic flux linkage with the rotor windings 42n and 42s while changing the circumferential width θ of the rotor windings 42n and 42s in the circumferential direction. In FIG. 5, the coil width θ is shown in terms of electrical angle. As shown in FIG. 5, as the coil width θ decreases from 180°, the variation width of the magnetic flux linkage with the rotor windings 42n and 42s increases. Therefore, by making the coil width θ smaller than 180°, that is, by providing the rotor windings 42n and 42s by the short-pitch winding method, the amplitude of the magnetic flux linkage due to the spatial harmonics is increased, in comparison with the full-pitch winding method.

Therefore, in the rotary electric machine 10 (FIG. 1), by making the width of the teeth 19 in the circumferential direction smaller than the width that corresponds to 180° in electrical angle and by winding the rotor windings 42n and 42s around the teeth 19 by the short-pitch winding method, the induced electromotive force produced in the rotor windings 42n and 42s by the spatial harmonics is efficiently increased. As a result, the torque that acts on the rotor 14 can be efficiently increased.

Furthermore, as shown in FIG. 5, in the case where the coil width θ is 90°, the amplitude of the magnetic flux linkage due to the spatial harmonics becomes maximum. Therefore, in order to further increase the amplitude of the magnetic flux linkage with the rotor windings 42n and 42s due to the spatial harmonics, it is preferable that the coil width θ of the rotor windings 42n and 42s in the circumferential direction be equal (or substantially equal) to a width that corresponds to 90° in the electrical angle of the rotor 14. Therefore, it is preferable that the width θ of the rotor windings 42n and 42s in the circumferential direction satisfy (or substantially satisfy) the following expression (2), where p is the number of pairs of poles of the rotor 14, and r is the distance from the rotation center axis of the rotor 14 to the rotor windings 42n and 42s.

θ=π×r/(2×p) (2)

In this manner, the induced electromotive force produced in the rotor windings 42n and 42s by the spatial harmonics can be maximized, and therefore the magnetic flux produced through each tooth 19 by the induced current can be most efficiently increased. As a result, the torque that acts on the rotor 14 can be more efficiently increased. Specifically, if the width θ greatly exceeds the width, that corresponds to 90°, it becomes likely that magnetomotive forces in mutually cancelling-out directions link with the rotor windings 42n and 42s, and this likelihood decreases as the width θ decreases from the width that corresponds to 90°. However, if the width θ becomes greatly smaller than the width that corresponds to 90°, the magnitude of the magnetomotive forces that link with the rotor windings 42n and 42s greatly declines. Therefore, by setting the width θ equal to the width that corresponds to about 90°, the foregoing inconveniences can be prevented. Therefore, it is preferable that the width θ of the rotor windings 42n and 42s in the circumferential direction be substantially equal to the width that corresponds to 90° in electrical angle.

Besides, in the rotary electric machine 10, it is also possible to control the torque of the rotor 14 by controlling the electric current lead angle relative to the rotor position, that is, the phase of the alternating electric current that is passed through the stator windings 28u, 28v, and 28w. Furthermore, the torque of the rotor 14 can be controlled also by controlling the amplitude of the alternating electric current that is passed through the stator windings 28u, 28v, and 28w. Besides, since changing the rotation speed of the rotor 14 also changes the torque of the rotor 14, the torque of the rotor 14 can be controlled also by controlling the rotation speed of the rotor 14.

Incidentally, in the foregoing description, as for each auxiliary pole 48, the base portion 52 is formed of a non-magnetic material, and the distal end portion 54 is formed of a magnetic material, and the thickness T2 of the distal end portion 54 in the circumferential direction is larger than the thickness T1 of the base portion 52 in the circumferential direction. However, this embodiment is not limited to this construction. For example, the entire body of each auxiliary pole 48 that includes the base portion 52 and the distal end portion 54 can be formed of a magnetic material while the shape of each auxiliary pole 48 is kept identical to the shape shown in FIGS. 1 to 3.

Alternatively, it is also possible to adopt a construction in which the entire body of each auxiliary pole 48 is formed of a magnetic material, and the thickness of each auxiliary pole 48 in the circumferential direction is consistent between the base portion 52 and the distal end portion 54 and therefore the stepped portion 56 (FIG. 3) is absent. However, in this case, the magnetic flux that should pass through the teeth 19 so as to produce magnetic attraction forces between the rotor 14 and the stator 12 cannot be effectively prevented from decreasing, and the effect of restraining an increase of the self-inductance of the rotor windings 42n and 42s cannot be obtained. Therefore; the effect of being able to increase the current induced in the rotor windings 42n and 42s is less than in the construction shown in FIG. 1 to 3. However, in this case, too, the effect of being able to increase the spatial harmonics, in particular, the spatial second harmonic, that link with the rotor windings 42n and 42s is obtained, so that the torque of the rotary electric machine 10 is increased.

Therefore, in the case where the entire body of each auxiliary pole 48 is formed of a magnetic material, it is preferable that the thickness T2 of the distal end portion 54 in the circumferential direction be larger than the thickness T1 of the base portion 52 in the circumferential direction as in the above-described construction shown in FIG. 1 to 3. In this case, the magnetic flux that should pass through the teeth 19 in order to produce magnetic attraction forces between the rotor 14 and the stator 12 can be effectively prevented from decreasing, and an increase of the self-inductance of the rotor windings 42n and 42s can be restrained, and the torque of the rotary electric machine 10 can be further enhanced.

Meanwhile, as long as the base portion 52 of each auxiliary pole 48 is formed of a non-magnetic material, even when the thickness of each auxiliary pole 48 in the circumferential direction is the same between the base portion 52 and the distal end portion 54, the effect of being able to enhance the torque of the rotary electric machine 10 is obtained as in the case where the entire body of each auxiliary pole 48 is formed of a magnetic material and where the thickness T2 of the distal end portion 54 in the circumferential direction is larger than the thickness T1 of the base portion 52 in the circumferential direction. That is, even in the former case, the magnetic flux that should pass through the teeth 19 in order to produce magnetic attraction forces between the rotor 14 and the stator 12 can be effectively prevented from decreasing, and an increase of the self-inductance of the rotor windings 42n and 42s can be restrained.

Hence, in the embodiment, preferably, the distal end portion 54 of each auxiliary pole 48 is formed of a magnetic material, and the base portion 52 thereof is formed of a non-magnetic material, and the thickness T1 of the base portion 52 of each auxiliary pole 48 in the circumferential direction and the thickness T2 of the distal end portion 54 thereof in the circumferential direction are made equal. Alternatively, the entire body of each auxiliary pole 48 may be formed of a magnetic material, and the thickness T2 of the distal end portion 54 in the circumferential direction may be made larger than the thickness T1 of the base portion 52 in the circumferential direction.

More preferably, as in the above-described construction shown in FIGS. 1 to 3, the distal end portion 54 of each auxiliary pole 48 is formed of a magnetic material and the base portion 52 thereof is formed of a non-magnetic material, and the thickness T2 of the distal end portion 54 in the circumferential direction is made larger than the thickness T1 of the base portion 52 in the circumferential direction.

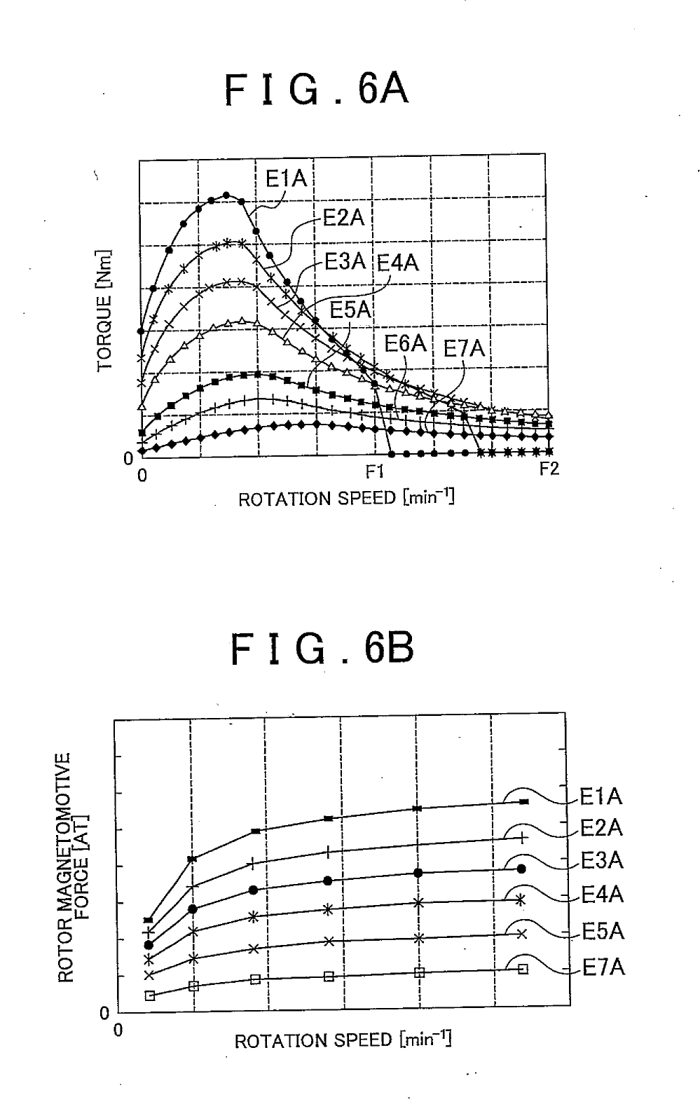

Next, results of simulations performed in order to confirm the effects of the embodiment equipped with the auxiliary poles 48 will be described together with results of simulations performed with a rotary electric machine as a comparative example that is excluded from the invention. In the following description, the elements comparable to those shown in FIGS. 1 to 4 are denoted by the same reference characters. Firstly, with reference to FIGS. 6A and 6B, results with the comparative example will be described. FIG. 6A is a diagram showing rotation speed-torque characteristics with different stator currents as results obtained from a simulation performed with the rotary electric machine of the comparative example that does not have any auxiliary poles 48. It is to be noted herein that the rotary electric machine of the comparative example used in this simulation was a rotary electric machine having substantially the same construction as that shown in FIGS. 1 to 3, except that it is not equipped with auxiliary poles 48 between adjacent teeth 19, which are the salient poles, on the rotor 14. With this construction of the comparative example, a simulation for finding a relation between the torque and the rotation speed was performed. FIG. 6A shows results of the simulation. The indications, E1A, E2A . . . , shown in FIG. 6A indicate that the effective values of the three-phase alternating electric currents when stator currents, that is, currents passed through the stator windings 28u, 28v, and 28w, are supplied are different, and indicate that the effective values of the stator current gradually decrease in the order of E1, E2 . . . .

As shown in FIG. 6A, in the rotary electric machine of the comparative example, the torque was small in a low rotation speed region, but in an intermediate rotation speed region, the maximum torque became large, and the torque became smaller from the intermediate rotation speed region to a high rotation speed region.

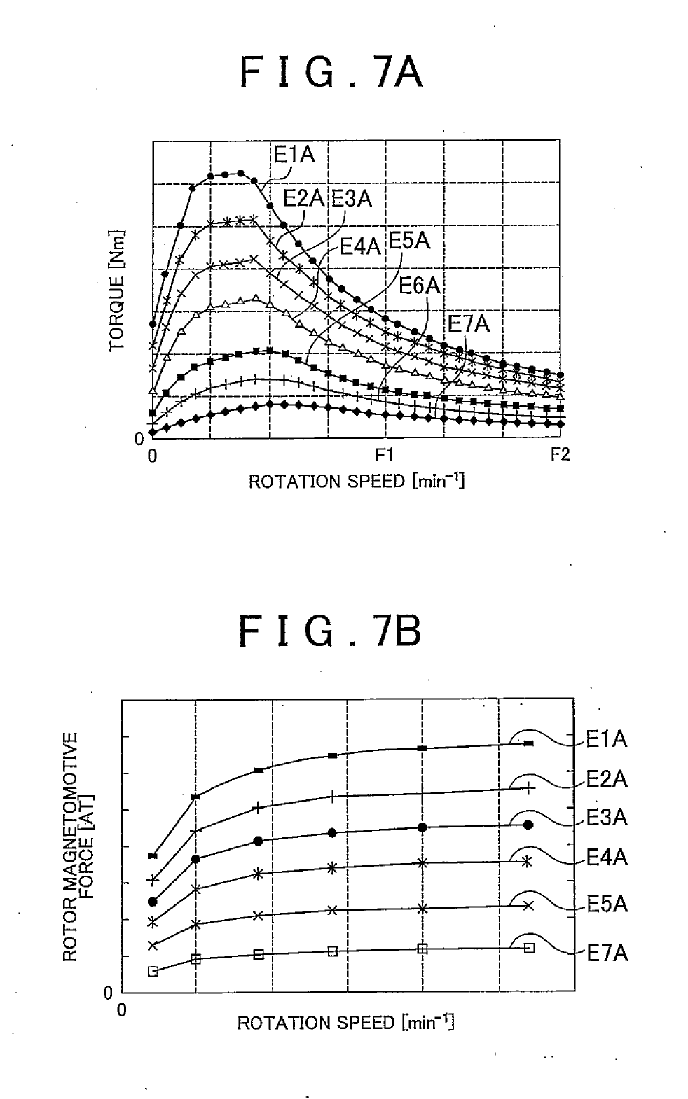

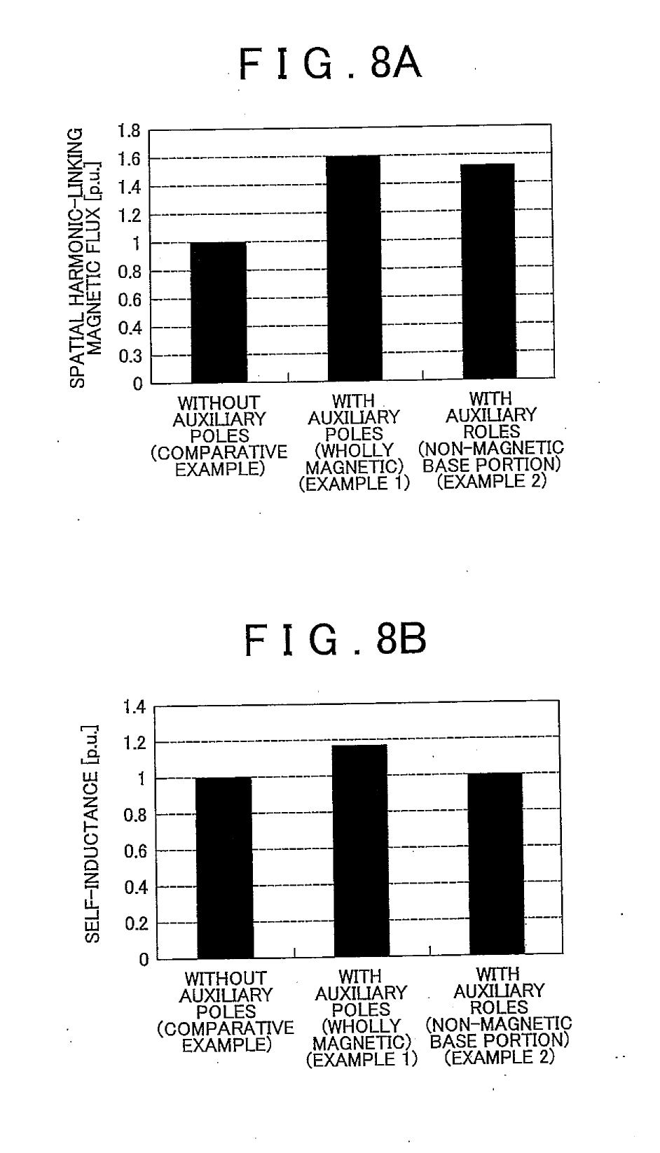

FIG. 6B is a diagram showing relations between the rotor magnetomotive force and the rotation speed with different stator currents as results obtained from a simulation performed with the rotary electric machine of the comparative example. The indications, E1A, E2A . . . , which represent current in FIG. 6A mean the same as those in FIG. 6A, and the same indications in FIGS. 6A and 6B represent the same effective values of the stator current (which also applies to FIGS. 7A and 7B). In FIG. 6B, the vertical axis represents the rotor magnetomotive force in ampere-turn. Since the numbers of turns of all the rotor windings 42n and 42s are equal, the vertical axis in FIG. GB corresponds to the rotor's induced current induced in the rotor windings 42n and 42s. As is apparent from the results shown in FIG. 6B, the rotor magnetomotive force gradually increases to predetermined rotation speeds as the rotation speed increases.

In contrast, FIGS. 7A and 7B show results of simulations performed with the rotary electric machine 10 of the embodiment shown in FIGS. 1 to 3. FIG. 7A is a diagram showing rotation speed-torque characteristics with different stator currents, as results obtained from a simulation performed with the rotary electric machine 10 of the embodiment of the invention. As is apparent from comparison between FIG. 6A and FIG. 7A, in the embodiment of the invention as compared with the comparative example, the maximum torques were greater for equal stator currents; for example, with the effective value E1A of the stator current, the maximum torque in the embodiment shown in FIG. 7A was 1.032 in comparison with the maximum torque of 1.0 in the comparative example shown in FIG. 6A, that is, the maximum torque in the embodiment had an increase of about 3%. At a rotation speed of F1 min⁻¹, the torque produced by E1A in FIG. 7A was 1.45 in comparison with the torque of 1.0 produced by E1A in FIG. 6A, that is, had an increase of 45%. At a rotation speed of F2 min⁻¹, the torque produced by E1A in FIG. 7A was 2.0 in comparison with the torque of 1.0 produced by E1A in FIG. 6A, that is, increased to double thereof. Incidentally, in FIG. 6A and FIG. 7A, the scale divisions along the vertical axis and the scale divisions along the horizontal axis respectively represent equal magnitudes between the two diagrams. Thus, it has been confirmed that the embodiment is able to increase the torque in substantially the entire region of rotation speed in comparison with the comparative example.

FIG. 7B is a diagram showing relations between the rotor magnetomotive force and the rotation speed with different stator currents as results obtained from a simulation performed with the rotary electric machine of the embodiment of the invention. As is apparent from comparison between FIG. 6B and FIG. 7B, it has been confirmed that in the embodiment, the rotor magnetomotive force can be made greater than in the comparative example over substantially the entire region of rotation speed, and that the rotor's induced current produced in the rotor windings 42n and 42s can also be made greater than in the comparative example over substantially the entire region of rotation speed. Incidentally, in FIG. 6B and FIG. 7B, the scale divisions along the vertical axis and the scale divisions along the horizontal axis respectively represent equal magnitudes between the two diagrams.

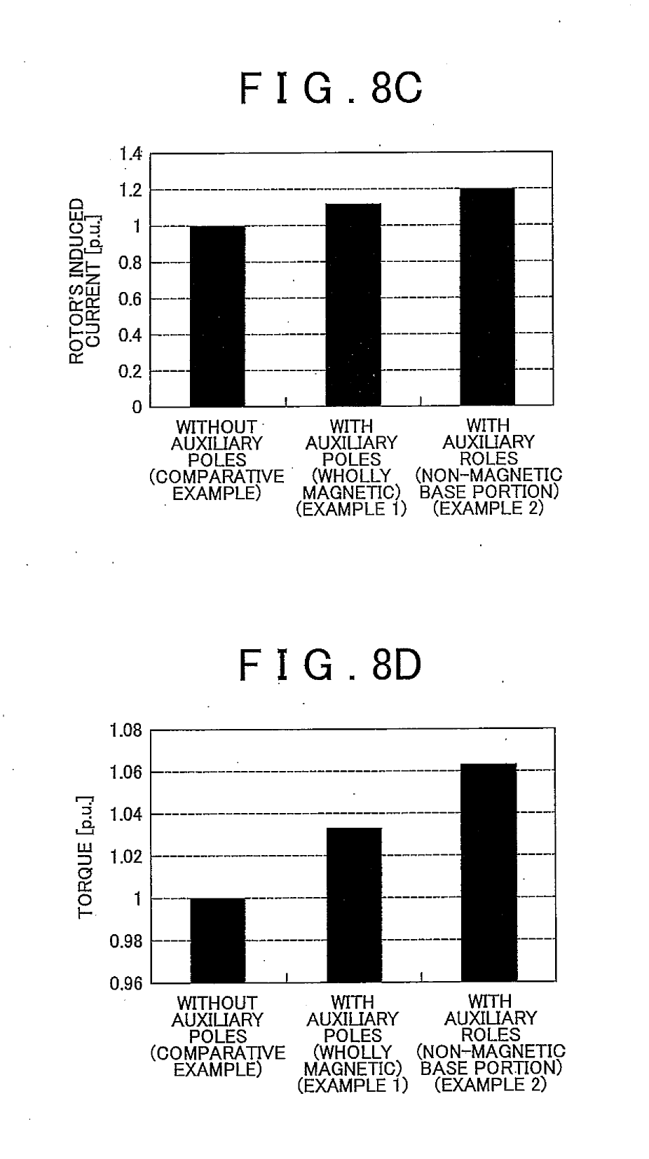

Next, the effects achieved by the auxiliary pole. 48 and the effects achieved in the case where the base portion 52 of each auxiliary pole 48 is formed of a non-magnetic material will be confirmed on the basis of results of calculation, with reference to FIGS. 8A to 8D. FIG. 8A is a diagram showing the spatial harmonic flux linkages of the rotor windings 42n and 42s, and FIG. 8B is a diagram showing the self-inductances of the rotor windings 42n and 42s. FIG. 8C is a diagram showing the rotor's induced currents through the rotor windings 42n and 42s, and FIG. 8D is a diagram showing the torques of rotary electric machines. In each of FIGS. 8A to 8C, comparison is made among the above-described rotary electric machine of the comparative example not provided with an auxiliary pole 48, and rotary electric machines of Examples 1 and 2. Example 1 is a rotary electric machine based on the above-described embodiment shown in FIGS. 1 to 3 which is provided with auxiliary poles 48 that are entirely formed of a magnetic material. Example 2 is a rotary electric machine based on the above-described embodiment shown in FIGS. 1 to 3 which is provided with auxiliary poles 48 whose distal end portions 54 are formed of a magnetic material, and whose base portions 52 are formed of a non-magnetic material: In FIG. 8A to FIG. 8D, the scale divisions of the vertical axis represent relative values of the flux linkage, the self-inductance, the induced current and the torque where those values of the comparative example were defined as 1.

As is apparent from FIG. 8A, the spatial harmonic flux linkages of the rotor windings 42n and 42s were small in the comparative example, and were large in both Examples 1 and 2. More specifically, the spatial harmonic flux linkage was slightly greater in Example 1 than in Example 2. Besides, as is apparent from FIG. 8B, the self-inductances of the rotor windings 42n and 42s were the largest in Example 1 in which the whole auxiliary poles 48 were formed of a magnetic material, and were equally small in the comparative example and Example 2. It is considered that this resulted from the short circuit of magnetic flux passing through the teeth 19 to the base portions 52 of the auxiliary poles 48 in Example 1. As is apparent from FIG. 8C, the rotor's induced currents gradually increased in the order of the comparative example, Example 1 and Example 2. It is considered that this resulted from increases in the self-inductance in Example 1 as shown in FIG. 8B. Besides, as is apparent from FIG. 8D, the torque of the rotary electric machine gradually increased in the order of the comparative example, Example 1 and Example 2 according to their different rotor's induced currents. From these results, too, it can be understood that in the embodiment, the torque of the rotary electric machine 10 can be increased, and even greater effects can be attained by forming the base portion 52 of each auxiliary pole 48 of a non-magnetic material.

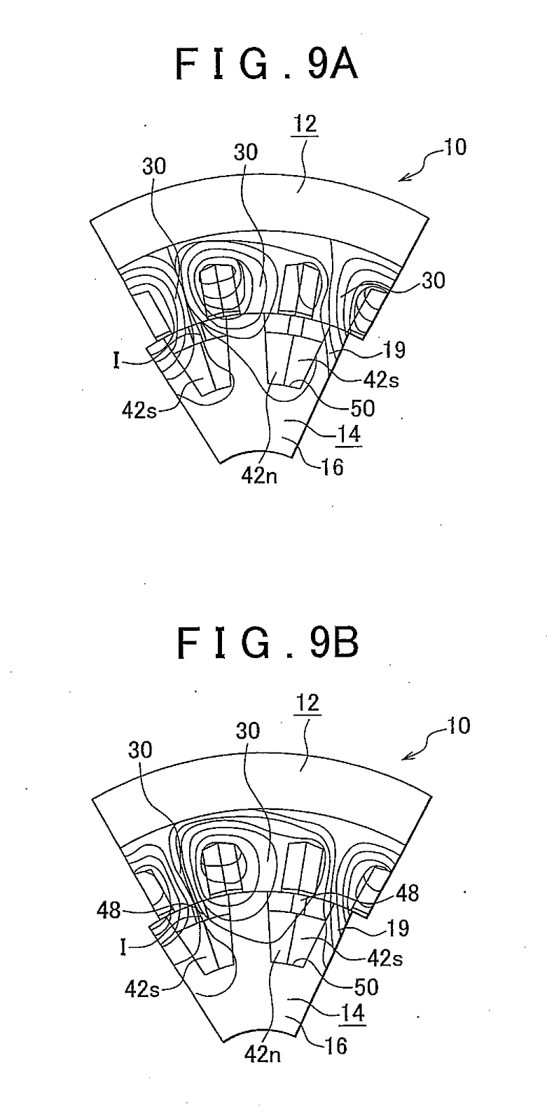

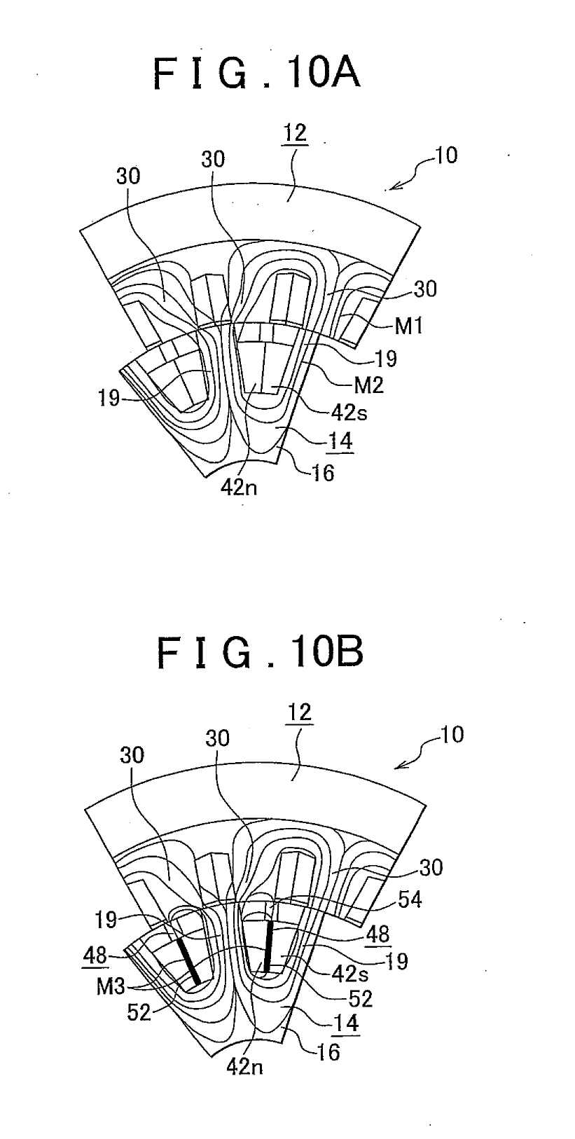

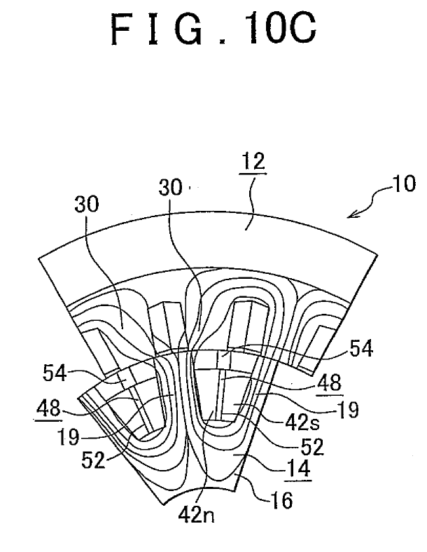

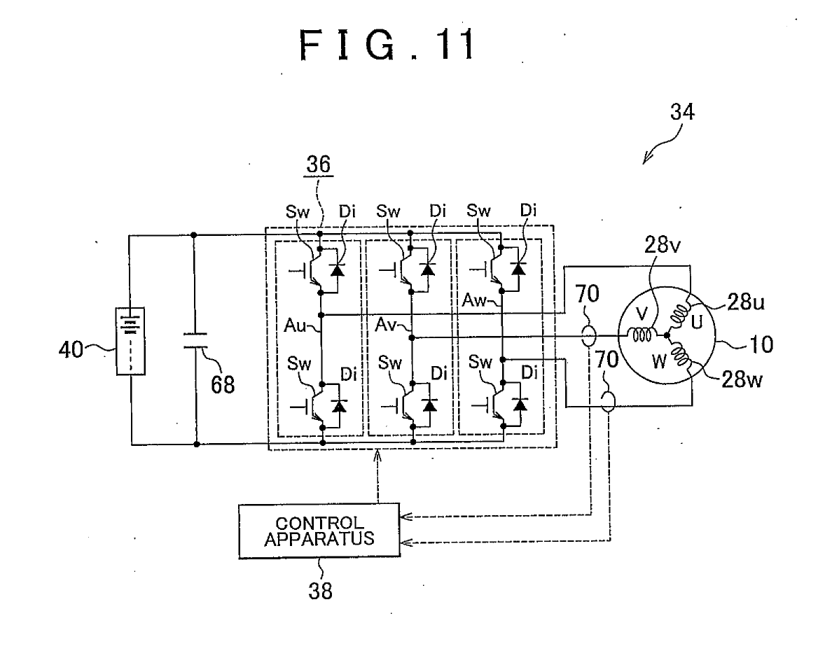

Next, with reference to FIGS. 9A and 9B, results of simulations regarding the magnetic flux of spatial harmonics of a rotary electric machine will be described. FIGS. 9A and 9B are schematic diagrams each showing magnetic flux of spatial harmonics. FIG. 9A shows the case of the above-described comparative example, and FIG. 9B shows the case of the embodiment shown in FIGS. 1 to 3. Incidentally, although FIG. 9A shows configurations that appear to be auxiliary poles 48, simulation results were calculated on the assumption that no auxiliary pole 48 was provided (which applies to FIG. 10A (described later) as well). In FIGS. 9A and 9B, the phase relation between the rotor 14 and the stator 12 is the same. In this case, a tooth 30 of the stator 12 faces a position indicated by “I” that corresponds to an auxiliary pole 48.

From the simulation results, it can be understood that in the embodiment shown in FIG. 9B provided with the auxiliary poles 48, more magnetic flux of spatial second harmonic links with the rotor windings 42n and 42s so as to pass through the auxiliary poles 48 than in the comparative example show in FIG. 9A not provided with an auxiliary pole 48. Besides, in FIG. 9B, the auxiliary poles 48 are disposed so as to be apart from the bottom portions of the slots 50, and the embodiment can also be constructed in this manner. In that case, for example, the auxiliary poles 48 are constructed by joining the auxiliary poles 48 at their axial end portions to metal plates or end plates that are provided on two opposite ends of the rotor 14 in the axis direction, or the like.

Next, with reference to FIGS. 10A to 10C, results of simulations regarding magnetic flux caused by the rotor's induced currents of a rotary electric machine are described. FIGS. 10A to 10C are schematic diagrams each showing magnetic flux created by the rotor's induced currents. FIG. 10A shows the case of the above-described comparative example. FIG. 10B shows the case of Example 1 of the embodiment shown in FIGS. 1 to 3 in which the base portion 52 of each auxiliary pole 48 is made of a magnetic material. FIG. 10C shows the case of Example 2 of the embodiment in which the base portion 52 of each auxiliary pole 48 is made of a non-magnetic material. In all of FIGS. 10A to 10C, the phase relation between the rotor 14 and the stator 12 is the same. In this case, a tooth 30 of the stator 12 denoted by M1 in FIG. 10A and a tooth 19 of the rotor 14 denoted by M2 in FIG. 10A partially face each other in a radial direction. The simulation results indicate that in Example 1 shown in FIG. 10B, since the base portion 52 of each auxiliary pole 48 is formed of a magnetic material, much magnetic flux passes through the base portion 52 denoted by M3. Therefore, it can be understood that the magnetic flux that short-circuits through auxiliary poles 48 increases the inductance of the rotor windings 42n and 42s.

On the other hand, in the comparative example without an auxiliary pole 48 shown in FIG. 10A and Example 2 shown in FIG. 10C in which the base portion 52 of each auxiliary pole 48 is formed of a non-magnetic material, there is no magnetic flux that short-circuits through auxiliary poles 48 unlike Example 1, so that increase in the inductance of the rotor windings 42n and 42s can be restrained more than in Example 1. As a result, according to Example 2 shown in FIG. 10C in which the flux linkage of the spatial second harmonic with the rotor windings 42n and 42s can be increased and increase in the inductance of the rotor windings 42n and 42s can be restrained, it is possible to make the torque of the rotary electric machine 10 even greater.

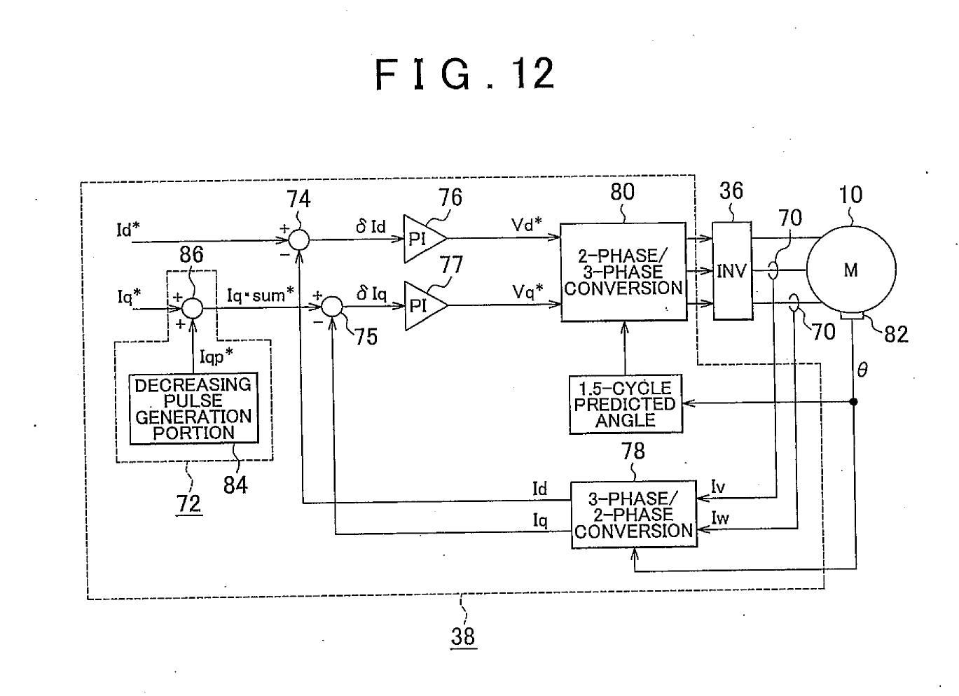

Next, with reference to FIGS. 11 to 14C, a rotary electric machine drive system 34 of an embodiment of the invention that includes the rotary electric machine of the foregoing embodiment will be described. Incidentally, the embodiment shown in FIGS. 11 to 14C has been devised for the purpose of increasing the torque in a low-rotation speed region in addition to the aforementioned torque-increasing effect, by superimposing pulse current on the q-axis current of the rotary electric machine 10.

FIG. 11 is a diagram showing a general construction of the rotary electric machine drive system of the embodiment of the invention. The rotary electric machine drive system 34 of the embodiment of the invention includes a rotary electric machine 10, an inverter 36 that is a drive portion that drives the rotary electric machine 10, a control device 38 that controls the inverter 36, and an electricity storage device 40 that is an electric power source portion, and thereby drives the rotary electric machine 10. The construction of the rotary electric machine 10 is the same as that of the rotary electric machine 10 shown in FIGS. 1 to 3. In the following description, the same elements as those shown in FIGS. 1 to 3 are denoted by the same reference characters.

The electricity storage device 40 is provided as a direct-current power source, and is chargeable and dischargeable, and is constructed of, for example, a secondary battery. The inverter 36 has three phase arms Au, Av, and Aw of a U-phase, a V-phase and a W-phase, and each of the three phase arms Au, Av, and Aw has two switching elements Sw that are connected in series. Each switching element Sw is a transistor, an IGBT, etc. A diode D1 is connected in reverse parallel with each switching element Sw. Furthermore, the midpoint of each of the arms Au, Av, and Aw is connected to an end side of a corresponding phase one of the stator windings 28u, 28v, and 28w that constitute the rotary electric machine 10. As for the stator windings 28u, 28v, and 28w, the stator windings of each phase are interconnected in series, and the stator windings 28u, 28v, and 28w of the different phases are connected at a neutral point.

Besides, the positive electrode side and the negative electrode side of the electricity storage device 40 are connected to the positive electrode side and the negative electrode side, respectively, of the inverter 36. A capacitor 68 is connected between the electricity storage device 40 and the inverter 36 so that the capacitor 68 is connected in parallel with the inverter 36. The control device 38 calculates a target torque of the rotary electric machine 10, for example, according to an acceleration command signal input from an accelerator pedal sensor (not shown) of the vehicle or the like, and controls the switching operation of each switching element Sw according to an electric current command value that is commensurate with the target torque or the like. The control device 38 receives input of signals that represent values of current detected by electric current sensors 70 provided at at least two phase stator windings (e.g., the windings 28u and 28v), and a signal that represents the rotation angle of the rotor 14 of the rotary electric machine 10 detected by a rotation angle detection portion 82 (FIG. 12) such as a resolver or the like. The control device 38 includes a microcomputer that has a central processing unit (CPU), a memory, etc., and controls the torque of the rotary electric machine 10 by controlling the switching of the switching elements Sw of the inverter 36. The control device 38 may include a plurality of separate controllers that have different functions.

This control device 38 makes it possible to convert the direct-current electric power from the electricity storage device 40 into alternating-current electric power of three phases, that is, the u-phase, the v-phase, and the w-phase, by the switching operations of the switching elements Sw that constitute the inverter 36, and supply electric power of phases that correspond to the phases of the stator windings 28u, 28v, and 28w. According to the control device 38 as described above, the torque of the rotor 14 (FIGS. 1 to 3) can be controlled by controlling the phases (current lead angles) of the alternating electric currents that are passed through the stator windings 28u, 28v, and 28w. The rotary electric machine drive system 34 is mounted for use, for example, as a vehicle driving power generating apparatus in a hybrid vehicle equipped with an engine and a traction motor as drive power sources, a fuel-cell vehicle, a pure electric vehicle, etc. Incidentally, a DC/DC converter as a voltage conversion portion may be connected between the electricity storage device 40 and the inverter 36 so that the voltage of the electricity storage device 40 can be raised and then supplied to the inverter 36.

FIG. 12 is a diagram showing a construction of an inverter control portion in the control device 38. The control device 38 includes an electric current command calculation portion (not shown), a decreasing pulse superimposition means 72, subtractors 74 and 75, PI computation portions 76 and 77, a three-phase/two-phase conversion portion 78, a two-phase/three-phase conversion portion 80, the rotation angle detection portion 82, a pulse width modulation (PWM) signal generation portion (not shown), and a gate circuit (not shown).

The electric current command calculation portion, following a table prepared beforehand or the like, calculates electric current command values Id* and Iq* that correspond to the d-axis and the q-axis, according to the torque command value of the rotary electric machine 10 calculated according to the acceleration instruction input from a user. It is to be noted herein that the d-axis is along a magnetic pole direction that is the direction of a winding center axis of the rotor windings 42n and 42s and the q-axis is along a direction that is advanced from the d-axis by 90° in electrical angle, in the circumferential direction of the rotary electric machine 10. For example, in the case where the rotation direction of the rotor 14 is prescribed as shown in FIG. 1, the d-axis direction and the q-axis direction are prescribed in a relation as indicated by arrows in FIG. 1. Besides, the electric current command values Id* and Iq* are a d-axis current command value that is a command value of a d-axis current component and a q-axis current command value that is a command value of a q-axis current component, respectively. By using the d-axis and the q-axis described above, it is made possible to determine the currents that are passed through the stator windings 28u, 28v, and 28w by vector control.

The three-phase/two-phase conversion portion 78 calculates a d-axis current value Id and a q-axis current value Iq of two phase currents from the rotation angle θ of the rotary electric machine 10 detected by the rotation angle detection portion 82 provided in the rotary electric machine 10 and the currents of two phases (e.g., the currents Iv and Iw of the V-phase and the W-phase) detected by the electric current sensors 70. A reason why only the currents of two phases are detected by the electric current sensors 70 is that since the sum of the currents of three phases is zero, the current of the other phase can be found by calculation. However, it is also possible to detect the currents of the U-phase, the V-phase, and the W-phase and calculate a d-axis current value Id and a q-axis current value Iq from the detected values of current.

The decreasing pulse superimposition means 72 has a decreasing pulse generation portion 84 that generates a decreasing pulse current, and an adding portion 86 that superimposes a decreasing pulse current Iqp* on, that is, adds it to, the q-axis current command value Iq* in constant cycles, and that outputs the post-superimposition q-axis current command value Iqsum* obtained by the addition, to the corresponding subtractor 75. Besides, the subtractor 74 that corresponds to the d-axis determines a deviation 81d between the d-axis current command value Id* and the d-axis current Id obtained through the conversion by the three-phase/two-phase conversion portion 78, and inputs the deviation SId to the PI computation portion 76 that corresponds to the d-axis.

Besides, the subtractor 75 that corresponds to the q-axis determines a deviation δIq between the post-superimposition q-axis current command value Iqsum* and the q-axis current Iq obtained through the conversion by the three-phase/two-phase conversion portion 78, and inputs the deviation δIq to the PI computation portion 77 that corresponds to the q-axis. The PI computation portions 76 and 77 determine control deviations regarding the input deviations δId and δIq by performing PI computation based on a predetermined gain, and calculate a d-axis voltage command value Vd* and a q-axis voltage command value Vq* commensurate with the control deviations.

The two-phase/three-phase conversion portion 80 converts the voltage command values Vd* and Vq* input from the PI computation portions 76 and 77 into voltage command values Vu, Vv, and Vw of three phases, that is, the u-phase, the v-phase, and the w-phase, on the basis of a predicted angle, that is, a predicted position, at the time of 1.5 control cycles later, which is obtained from the rotation angle θ of the rotary electric machine 10. The voltage command values Vu, Vv, and Vw are converted into a PWM signal by a PWM signal generation portion (not shown), and the PWM signal is output to a gate circuit (not shown). The gate circuit controls the on/off state of the switching elements Sw by selecting a switching element Sw to which the control signal is applied. Thus, the control device 38 converts the stator currents that flow through the stator windings 28u, 28v, and 28w into the dq-axis coordinate system to obtain a d-axis current component and a q-axis current component, and controls the inverter 36 so as to acquire a stator current of each phase that corresponds to a target torque, through the vector control that includes feedback control.

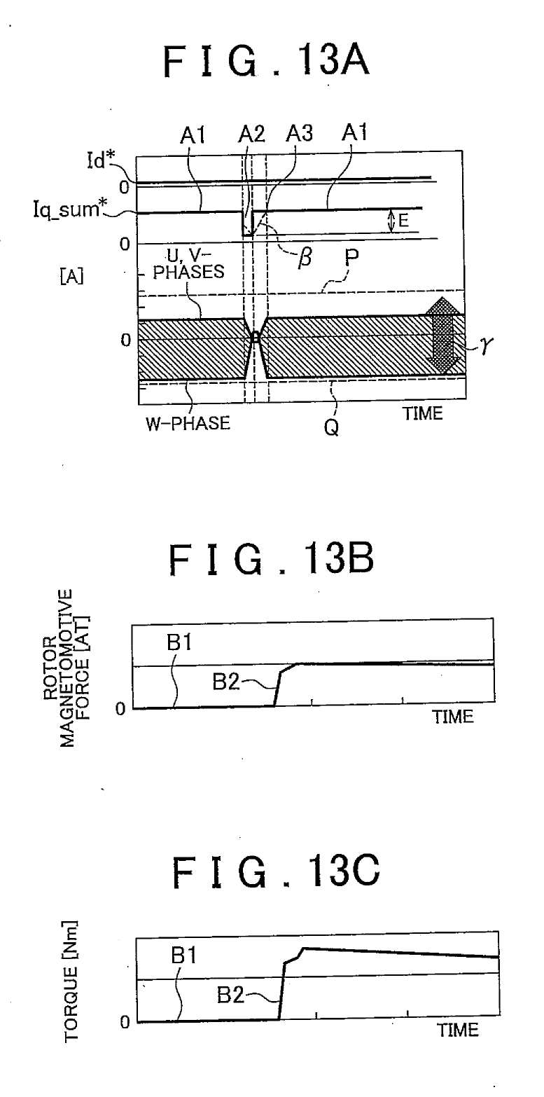

FIG. 13A is a diagram showing an example of time-dependent changes in the stator current in the embodiment of the invention in terms of the d-axis current command value Id*, the post-superimposition q-axis current command value Iqsum*, and the electric currents of the three phases. FIG. 13B is a diagram showing time-dependent changes in the rotor magnetomotive force corresponding to FIG. 13A. FIG. 13C is a diagram showing time-dependent changes in the motor torque corresponding to FIG. 13A. FIGS. 13A, 13B, and 13C show results of simulations in diagrams in each of which a very short time is shown in an expanded scale, that is, is expanded in the lateral direction. Therefore, although the U-phase, V-phase, and W-phase currents are actually in sine waves during the driving of the rotary electric machine, FIG. 13A shows the currents as being linear before and after the pulse currents are superimposed.

As shown in FIG. 13A, the decreasing pulse superimposition means 72 shown in FIG. 12 superimposes the decreasing pulse current only on the q-axis current command value Iq*. The d-axis current command value Id* is a constant value calculated corresponding to a torque command. Thus, an electric current command that decreases and then increases in a pulse fashion is superimposed on the q-axis current command value Iq* in constant cycles by the decreasing pulse superimposition means 72. Incidentally, as shown in FIG. 13A, even when the pulse current is commanded as being in a rectangular waveform, the pulse current sometimes becomes a pulse form combined with a curve as shown by an interrupted line β in reality due to delay in response. Besides, the pulse waveform of the decreasing pulse current may be any waveform, including rectangular waves, triangular waves, or waves formed into a prominent shape from a plurality of curves and straight lines.

If the decreasing pulse current is superimposed in the above-described manner, the absolute value of current decreases, for example, in the case where a maximum current flows through the stator winding of one phase and where equal currents flow through the stator windings of the other two phases and the sum of the equal currents flows through the stator winding of the one phase. For example, FIG. 13A shows the case where a maximum current flows through the stator winding 28w of the W-phase and where equal currents flow through the stator windings 28u and 28v of the other two phases, that is, the U-phase and the V-phase, and the sum of the equal currents flows through the stator winding of the W-phase. In this case, a double-headed arrow γ shows a restriction range of current, and interrupted lines P and Q show allowable limits of current that are required in design. Specifically, it is required that the value of current be between the interrupted lines P and Q, due to relations with various component parts, such as the capacity of the inverter 36 or the like. With these conditions, the value of the current that flows through the stator winding 28w of the W-phase is in the vicinity of the allowable limit. In this case, the superimposition of the decreasing pulse current reduces the absolute values of the values of current of the three phases, but the flux change in the spatial harmonics of the rotating magnetic field on the stator 12 according to changes in current increases. Therefore, the rotor magnetomotive force increases as shown in FIG. 13B, and the motor torque increases as shown in FIG. 13C. Besides, since the peak of the pulse currents of the U-phase and the V-phase on the positive side declines and the peak of the pulse current of the W-phase on the negative side rises, the currents of the three phases can be contained within the restriction range of current (the range represented by the double-headed arrow γ in FIG. 13A).

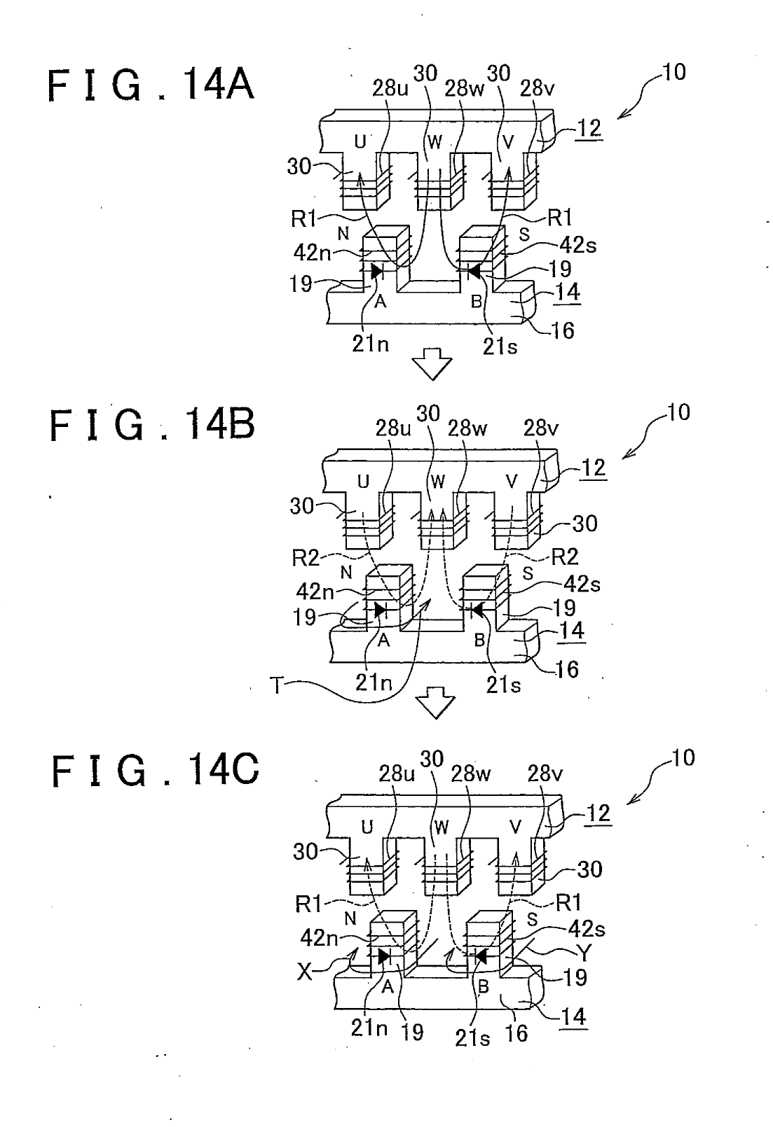

This will be explained further in detail with reference to FIGS. 14A to 14C. FIGS. 14A to 14C show schematic diagrams showing manners in which magnetic flux passes through the stator and the rotor in the embodiment of the invention, in the case (FIG. 14A) where the q-axis current is a constant value, an early period (FIG. 14B) of the case where the decreasing pulse current is superimposed on the q-axis current, and a late period (FIG. 14C) of the case where the decreasing pulse current is superimposed on the q-axis current. In FIGS. 14A to 14C, teeth 30 provided with the stator windings 28u, 28v, and 28w of the three phases do not radially face teeth 19 provided with the rotor windings 42n and 42s, so that a tooth 30 faces a middle position between two teeth 19 adjacent to each other in the circumferential direction of the rotor 14. In this state, the magnetic flux that flows between the stator 12 and the rotor 14 is q-axis flux as indicated by solid-line arrows R1 and interrupted-line arrows R2 in FIGS. 14A to 14C.

FIG. 14A corresponds to the state A1 shown in FIG. 13A in which the post-Superimposition q-axis current command value Iqsum* is a constant value, and FIG. 14B corresponds to an early period of the occurrence of the decreasing pulse current on the post-superimposition q-axis current command value Iqsum* in FIG. 13A, that is, the state A2 in FIG. 13A in which the command value Iqsura* sharply decreases. Besides, FIG. 14C corresponds to a late period of the occurrence of the decreasing pulse current on the post-superimposition q-axis current command value Iqsum* in FIG. 13A, that is, the state A3 in FIG. 13A in which the command value Iqsum* sharply increases.

Firstly, as shown in FIG. 14A, during the state during which the post-superimposition q-axis current command value Iqsum* prior to the occurrence of the decreasing pulse current is constant, magnetic flux flows, as shown by the solid-line arrows R1, from the tooth 30 of the W-phase to the teeth 30 of the U-phase and the V-phase, passing through the teeth 19 at positions A and B via the space between the teeth 19 at the positions A and B. In this case, positive currents flow through the stator windings 28u and 28v of the U-phase and the V-phase, and a negative large current flows through the stator winding 28w of the W-phase. However, in this case, there occurs no change in magnetic flux caused by the fundamental component that passes through the teeth 30.

On the other hand, as shown in FIG. 14B, during the early period of the occurrence of the decreasing pulse current, that is, during the state in which the q-axis current sharply decreases, the absolute values of the currents through the stator windings 28u, 28v, and 28w change in the direction of decrease and, apparently, magnetic flux flows in the opposite directions as shown by the interrupted-line arrows R2 due to changes from the state shown in FIG. 14A. Incidentally, the change in magnetic flux may be an actual reversal of positive and negative values of the stator current in which magnetic flux flows in the directions opposite to the directions of flux shown in FIG. 14A. In any case, magnetic flux flows in the tooth 19 at the position A in such a direction that the N pole of the tooth 19 at the position A changes to the S pole, and induced current tends to flow through the rotor winding 42n of the tooth 19 at the position A in such a direction as to inhibit the flowing of magnetic flux, and the flow of current in the direction of an arrow T in FIG. 14B is not blocked by the diode 21n. On the other hand, in the tooth 19 at the position B, magnetic flux flows in such a direction that the S pole of the tooth 19 at the position B is strengthened, and induced current tends to flow through the rotor windings 42s of the tooth 19 at the position B in such a direction as to inhibit the flow of flux, that is, in such a direction as to cause the tooth 19 at the position B to become the N pole; however, the flow of current in that direction is blocked by the diode 21s, and therefore current does not flow through the rotor winding 42s at the position B.

Subsequently, as shown in FIG. 14C, during the late period of the occurrence of the decreasing pulse current, that is, during the state in which the q-axis current sharply increases, the magnitudes of the currents through the stator windings 28u, 28v, and 28w change in the direction of increase, and magnetic flux flows in the directions opposite to the directions of flux in FIG. 14B, as shown by the solid-line arrows R1 in FIG. 14C. In this case, magnetic flux flows in the tooth 19 at the position A in such a direction as to strengthen the N pole of the tooth 19 at the position A, and induced current tends to flow through the rotor winding 42n of the tooth 19 at the position A in such a direction as to inhibit the flow of flux, that is, in such a direction as to cause the tooth 19 at the position A to become the S pole (direction X opposite to the direction of the diode 21n); however, since current is flowing already in FIG. 14B, the current gradually decreases at least during a certain time. Besides, in the tooth 19 at the position B, magnetic flux flows in such a direction that the S pole of the tooth 19 at the position B tends to change to the N pole, and induced current tends to flow through the rotor winding 42s of the tooth 19 at the position B in such a direction as to inhibit the flow of flux, and the flow of current in the direction of an arrow Y in FIG. 14C is not blocked by the diode 21n. As a result, as indicated by B2 in FIGS. 13B and 13C, the rotor magnetomotive force increases due to the superimposition of the decreasing pulse current on the q-axis current, and the motor torque increases.

Besides, when the decreasing pulse current becomes zero and the state returns to the state of FIG. 14A, the currents through the rotor windings 42n and 42s gradually decline. However, by cyclically superimposing the decreasing pulse current, the effect of increasing torque can be attained. Incidentally, while the case where the decreasing pulse current is superimposed when the current through the stator winding 28w of the W-phase becomes maximum has been described above, the cases of the currents through the windings 28u and 28v of the U-phase and the V-phase are the same as described above.

According to the rotary electric machine drive system 34 described above, it is possible to realize a rotary electric machine 10 that is capable of increasing the torque over the entire region and further increasing the torque in a low-rotation speed region while preventing excessively large currents from flowing through the stator windings 28u, 28v, and 28w. For example, in the case where the stator windings 28u, 28v, and 28w of a plurality of phases are stator windings of three phases, even when the absolute value of current through the stator winding of one phase (e.g., the W-phase) is higher than the absolute values of the currents that flow through the stator windings of the other phases (e.g., the U-phase and the V-phase) before the superimposition of the pulse current is performed for the stator winding of the one phase (e.g., the W-phase), the superimposition of the decreasing pulse current increases the induced current produced in the rotor windings 42n and 42s while lowering the absolute values of the currents that flow through the windings of all the phases in a pulse fashion. Therefore, it is possible to increase the torque of the rotary electric machine 10 even in a low-rotation speed region while restraining the peaks of the stator currents that are the currents passed through all the stator windings 28u, 28v, and 28w. Furthermore, due to the auxiliary pole 48 (FIGS. 1 to 3), the spatial harmonics, in particular, spatial second harmonic of the rotating magnetic field generated by the stator 12, that link with the rotor windings 42n and 42s are increased, and change in the magnetic flux is increased, and the induced current produced in the rotor windings 42n and 42s is further increased, and the torque in a low-rotation speed region is further increased. Besides, since there is no need to provide magnets on the rotor 14 side, it is possible to achieve both a magnet-less construction and a high torque construction.

Furthermore, as shown in FIG. 13A, by superimposing the decreasing pulse current on the q-axis current command, the absolute value of the current that flows through the stator winding of one phase, for example, the stator winding 28w of the W-phase, is decreased in a pulse fashion. However, the invention is not limited to a mode, in which the top of a peak of the current that changes in a pulse fashion is near zero. For example, the magnitude E of decrease (FIG. 13A) in the decreasing pulse current of the post-superimposition q-axis current command Iqsum* can be increased so that the negative current that flows through the stator winding 28w of the W-phase increases to the positive side after rising to the vicinity of 0. In this case, too, it is possible to increase the amount of change of the q-axis magnetic flux caused by the spatial harmonics and therefore increase the torque without excessively increasing the stator current.

In the case of the synchronous machine described in JP 2007-185082 A mentioned above, electromagnets are formed in the rotor by pulse current. In this machine, a rotor winding is provided so as to be wound around the rotor diametrically across the rotor on an outer peripheral portion thereof, and a rectifying element is connected to the rotor winding, so that two different magnetic poles are formed at diametrically opposite sides of the rotor. Therefore, even if a pulse current is superimposed on the q-axis current, the induced currents for forming two magnetic poles cancel out each other, so that induced current cannot be produced through the rotor winding. Specifically, this construction is not able to produce torque by superimposing a pulse current on the q-axis current.

Besides, in the case of the synchronous machine described in JP 2010-98908 A mentioned above, increasing pulse currents that increase and then decrease in a pulse fashion are superimposed on the d-axis current and the q-axis current, and therefore, there is a possibility that the peak of the current that flows through a stator winding may excessively rise. Besides, the synchronous machine described in JP 2010-11079 A mentioned above does not disclose any means for superimposing the decreasing pulse current on the q-axis current for the purpose of realizing a rotary electric machine capable of increasing the torque even in a low-rotation speed region while preventing excessively large currents from flowing through the stator windings.

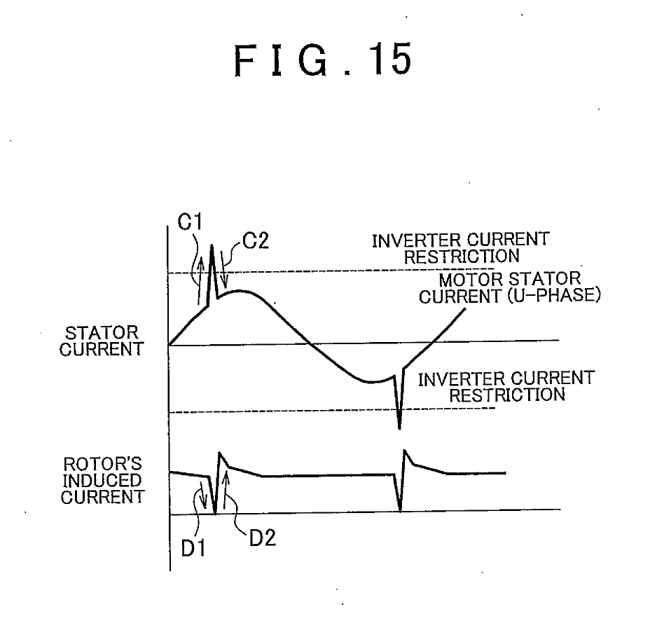

For example, FIG. 15 shows examples of the current that is passed through the stator winding of the U-phase (stator current) and the induced current created through a rotor winding (rotor's induced current) in a rotary electric machine drive system that superimposes the increasing pulse current on the stator currents, in an example of a construction different from the embodiment. The example shown in FIG. 15 is substantially the same as the embodiment, except that the increasing pulse current, instead of the decreasing pulse current, is superimposed. As shown in FIG. 15, in this example, an increasing pulse current that increases and then decreases in a pulse fashion is superimposed on the stator current of a sine wave. In this case, as in the case of the synchronous machines described in JP 2007185082 A and JP 2010-98908 A, as the stator current sharply rises as shown by an arrow C1, the rotor's induced current sharply decreases according to the principle of electromagnetic induction as shown by an arrow D1. After that, as the stator current sharply declines as shown by an arrow C2, the rotor's induced current increases. Due to this principle, the current that flows through one of the stator windings of the three phases increases. Therefore, in order to generate a desired torque, it sometimes becomes necessary to superimpose a large electric current pulse. In this case, the increasing pulse current is superimposed on the d-axis current. Therefore, it cannot be said that there is no possibility that the peak value of current may become excessively large and exceed the inverter current restriction limit required in design. Thus, it cannot be said that there is no possibility that the costs and size of the control system including the inverter may be increased because, for example, it becomes necessary to increase the capacity of the switching elements of the inverter. Besides, it cannot be said that there is no possibility that the size of the electric current sensor may be increased and the detection accuracy may be deteriorated because it is necessary to increase the detection range of the electric current sensor to be used to control electric current.

In contrast, according to the embodiment as described above, since the stator current can be prevented from becoming excessively large, that is, since the peak value of current can be prevented from excessively large, all the foregoing drawbacks and inconveniences can be solved. Incidentally, the rotary electric machine 10 of the embodiment shown in FIGS. 1 to 3 can be used in an example whose induced currents are shown in FIG. 15.

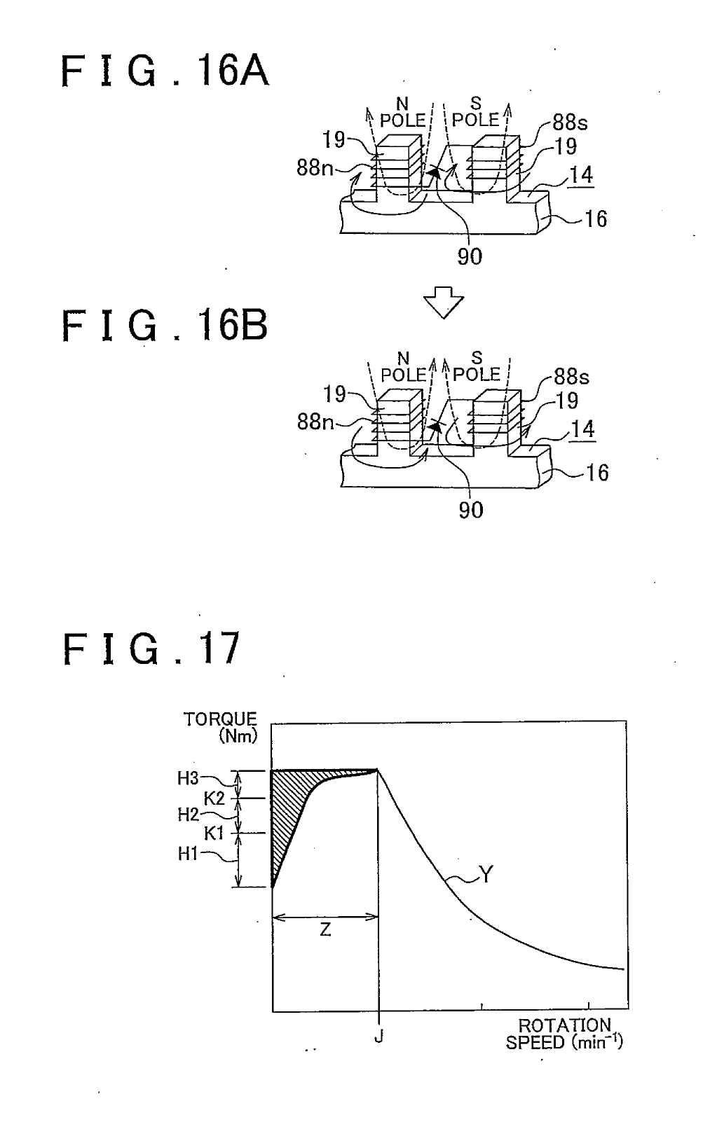

According to the embodiment as described above, the rotor windings 42n and 42s are connected to the diodes 21n and 21s that are rectifying elements such that the forward directions of the diodes 21n and 21s of the rotor windings 42n and 42s adjacent to each other in the circumferential direction of the rotor 14 are opposite to each other. Since the diodes 21n and 21s rectify the currents that flow through the rotor windings 42n and 42s due to production of induced electromotive forces, the phases of the electric currents that flow through the rotor windings 42n and 42s adjacent to each other in the circumferential direction are different from each other, that is, the A-phase and the B-phase alternate. Another embodiment different from the embodiment is also conceivable as shown in FIGS. 16A and 16B. FIGS. 16A and 16B show schematic diagrams of a rotor showing a change that occurs when the pulse current is superimposed on the q-axis current in another embodiment.

In the another embodiment shown in FIGS. 16A and 16B, rotor windings 88n and 88s are wound around teeth 19 provided at a plurality of locations in the circumferential direction of the rotor 14 and each pair of adjacent rotor windings 88n and 88s are interconnected via a diode 90 so that the magnetic characteristics of the pole portions formed by the currents that flow through the rotor windings 88n and 88s, that the magnetic characteristics of teeth 19, are varied alternately. Besides, in the example shown in FIGS. 16A and 16B, the rotor 14 is provided with auxiliary poles similarly to the embodiment shown in FIGS. 1 to 3 although the auxiliary poles are omitted from the illustrations in FIGS. 16A and 16B. In this another embodiment, in the case where q-axis magnetic flux of spatial harmonics due to superimposition of the pulse current on the q-axis current flows as indicated by interrupted-line arrows in FIGS. 16A and 16B, currents tend to flow so that both the N pole and the S pole become the S pole (FIG. 16A), but the currents at the N pole side and the S pole side cancel out each other. Besides, in the case where the q-axis magnetic flux flows in the directions opposite to the directions shown in FIG. 16A, currents tend to flow so that both the N pole and the S pole become the N pole (FIG. 16B), but the currents at the N pole side and the S pole side cancel out each other. Therefore, in the another embodiment shown in FIGS. 16A and 16B, the superimposition of the pulse current on the q-axis current does not induce currents through the rotor windings 88n and 88s. In contrast, the embodiment shown in FIGS. 1 to 3 is able to attain the torque-increasing effect by superimposing the pulse current on the q-axis current as described above. However, in the embodiment shown in FIGS. 16A and 16B, too, it is possible to produce torque on the rotor 14 by superimposing an increasing pulse current that has an increase in a pulse fashion on the d-axis current command for causing current to flow through the stator windings, etc.

Incidentally, in the embodiment described above with reference to FIGS. 11 to 14C, the control device 38 has the decreasing pulse superimposition means 72 for superimposing the decreasing pulse current on the q-axis current, and the pulse current is not superimposed on the d-axis current. However, the control device 38 may be constructed so as to have the decreasing pulse superimposition means 72 for superimposing the decreasing pulse current on the q-axis current command Iq* and increasing pulse superimposition means for superimposing on the d-axis current command Id* an increasing pulse current, that is, a pulse current that sharply increases and then sharply decreases in a pulse fashion. That is, as a rotary electric machine drive system, the control portion may be constructed so as to have decreasing/increasing pulse superimposition means for superimposing the decreasing pulse current on the q-axis current command Iq* and superimposing on the d-axis current command Id* the increasing pulse current that has an increase in a pulse manner.

According to this construction, it is possible to increase the amount of variation of the magnetic flux that is generated by the d-axis current so as to pass through the d-axis magnetic path while containing the stator currents of the three phases within an electric current restriction range. Therefore, it is possible to further increase the induced current in the rotor 14 to effectively increase the torque of the rotary electric machine 10. Specifically, it is possible to realize a rotary electric machine 10 capable of increasing the torque over the entire region and further increasing the torque in a low-rotation speed region while preventing excessively large current from flowing through the stator windings 28u, 28v, and 28w. More specifically, by superimposing the decreasing pulse current on the q-axis current command Iq* and the increasing pulse current on the d-axis current command Id*, it is possible to increase the induced currents produced in the rotor windings 42n and 42s while containing the currents of all the phases within the required current restriction range. Furthermore, since the increasing pulse current is superimposed on the d-axis current command Id*, it is possible to enlarge the amount of variation of the magnetic flux that is generated by the d-axis current command Id* and that passes through the d-axis magnetic path. The passage through air gap can be made less in the d-axis magnetic path corresponding to the d-axis current command Id* than in the q-axis magnetic path corresponding to the q-axis current command Iq*, so that the magnetic resistance lowers. Therefore, increasing the amount of variation of the d-axis magnetic flux is effective for increasing the torque. Therefore, it is possible to increase the current induced through the rotor windings 42n and 42s and therefore the torque of the rotary electric machine 10 even in a low-rotation speed region while restraining the peaks of the stator currents of all the phases. Besides, due to the auxiliary poles 48, it is possible to increase the spatial harmonics, in particular, the spatial second harmonic of the rotating magnetic field generated by the stator 12, that link with the rotor windings 42n and 42s, so that the change of the magnetic flux is enlarged, and the current induced through the rotor windings 42n and 42s is increased, and the torque of the rotary electric machine 10 in a low-rotation speed region is increased.

Besides, in the embodiment shown in FIGS. 11 to 14C, the decreasing pulse superimposition means 72 may be designed so that the decreasing pulse current is superimposed on the q-axis current command Iq* only when the present operation conditions fall within a predetermined region that is prescribed by the torque and the rotation speed of the rotary electric machine 10. For example, the decreasing pulse superimposition means 72 may also be designed so that the decreasing pulse current is superimposed on the q-axis current command Iq* only when the rotation speed of the rotary electric machine 10 is lower than or equal to a predetermined rotation speed and the torque of the rotary electric machine 10 is greater than or equal to a predetermined torque.

Besides, FIG. 17 is a diagram showing a relation between the rotation speed and the torque of the rotary electric machine for illustrating an example in which the state of superimposition of the pulse current is changed in the embodiment. Specifically, in the embodiment, as shown in FIG. 17, the mode of superimposition of the pulse current may be changed in three steps according to the ranges of rotation speed and of torque of the rotary electric machine 10, or according to the range of torque thereof. FIG. 17 shows a relation between the rotation speed and the torque of the rotary electric machine 10 in the case where a rotary electric machine drive system that does not superimpose the pulse current is used, in the embodiment. Therefore, in a range of low rotation speed indicated by a double-headed arrow Z, the torque of the rotary electric machine 10 is relatively low, and increase of the torque is desired within the range as shown by a hatched portion. This drawback can be solved by an embodiment in which the mode of superimposition of the pulse current is changed in three steps in a construction in which the control portion has the decreasing/increasing pulse superimposition means as mentioned above. In this embodiment, in the case where relations between the torque and the rotation speed are prescribed in an H1 region, an H2 region, and an H3 region shown in FIG. 17, the pulse current is superimposed on at least one of the d-axis current and the q-axis current by different modes corresponding to the three regions.

In the H1 region, that is, when the output torque of the rotary electric machine 10 is less than or equal to threshold value (K1 N·m) while the rotation speed of the rotor 14 is less than or equal to a predetermined rotation speed (J min⁻¹), the decreasing/increasing pulse superimposition means executes an increasing pulse mode of superimposing the increasing pulse current Idp* on the d-axis current command Id* but not superimposing the decreasing pulse current on the q-axis current command Iq*. Thus, when there is a good margin from the electric current restriction limit, the rotor current can be efficiently induced by the increasing pulse mode that uses only changes of the d-axis magnetic flux.

In the H2 region, that is, when the output torque of the rotary electric machine 10 exceeds the threshold value (K1 N·m) and is less than or equal to a second threshold value (K2 N·m) while the rotation speed of the rotor 14 is less than or equal to the predetermined rotation speed (T min⁻¹), the decreasing/increasing pulse superimposition means executes a decreasing/increasing pulse mode of superimposing the increasing pulse current Idp* on the d-axis current command Id* and superimposing the decreasing pulse current Iqp* on the q-axis current command Iq*. In the case where the margin from the electric current restriction limit is small as described above, it is possible to induce the rotor current within the range of the electric current restriction limit by the decreasing/increasing pulse mode of using changes of the q-axis magnetic flux as well as changes of the d-axis magnetic flux.

In the H3 region, that is, when the output torque of the rotary electric machine 10 exceeds the threshold value (K2 N·m) while the rotation speed of the rotor 14 is less than or equal to the predetermined rotation speed (J min⁻¹), the decreasing/increasing pulse superimposition means executes a decreasing pulse mode of superimposing the decreasing pulse current Iqp* on the q-axis current command Iq* but not superimposing the increasing pulse current on the d-axis current command Id*. Thus, in the vicinity of the electric current restriction limit, the decreasing pulse mode that uses only changes of the q-axis magnetic flux is employed, so that it is possible to increase the torque while preventing increase in the current by changing the stator currents of all the phases toward a center of the electric current restriction range.

Although the case where the different modes of superimposing of the pulse currents are used selectively for the three steps, that is, the H1 region, the H2 region and the H3 region, the mode of superimposition of the pulse current may be switched between two steps, that is, between the H1 region and the H2 region. In this case, while the rotation speed of the rotor 14 is less than or equal to the predetermined rotation speed, the decreasing/increasing pulse superimposition means executes the increasing pulse mode of superimposing the increasing pulse current on the d-axis current command but not superimposing the decreasing pulse current on the q-axis current command when the output torque is less than or equal to a threshold value; and when the output torque exceeds the threshold value, the decreasing/increasing pulse superimposition means executes the decreasing/increasing pulse mode of superimposing the increasing pulse current on the d-axis current command and superimposing the decreasing pulse current on the q-axis current command.

In the above-described example, the control device 38 that is a component of the rotary electric machine drive system 34 superimposes the pulse current on the q-axis current or the d-axis current. However, in the rotary electric machine drive system that includes the rotary electric machine 10 of the embodiment shown in FIGS. 1 to 3, it is also possible to adopt a construction that simply has a function of driving the inverters without provision of decreasing pulse superimposition means or decreasing/increasing pulse superimposition means.

Next, other examples of constructions of the rotary electric machine of the foregoing embodiments will be described. As shown below, the invention is applicable to various construction examples of the rotary electric machine.

For example, in the embodiment described above with reference to FIGS. 1 to 3, the rotor 14 has a construction in which the rotor windings 42n and 42s adjacent to each other in the circumferential direction are electrically separated, and the rotor windings 42n disposed on every other tooth 19 are electrically connected in series, and the rotor windings 42s disposed on every other tooth 19 (other than the teeth 19 provided with the windings 42n) are electrically connected in series. However, as shown in FIG. 18, the auxiliary poles 48 can be provided between the teeth 19 even in a rotary electric machine that includes a rotor 14 in which diodes 21n and 21s are connected one-to-one to the rotor windings 42n and 42s, respectively, that are wound around the teeth 19 that are rotor teeth, and in which the rotor windings 42n and the rotor windings 42s are electrically separated from each other. Specifically, on the rotor core 16, a plurality of auxiliary poles 48 each of which is made at least partially of a magnetic material are provided between adjacent teeth 19, that is, each auxiliary pole 48 is provided on a central portion of the bottom of a slot 50 between two adjacent teeth 19 in the circumferential direction of the rotor 14. Other constructions are the same as those of the embodiment shown in FIGS. 1 to 3.

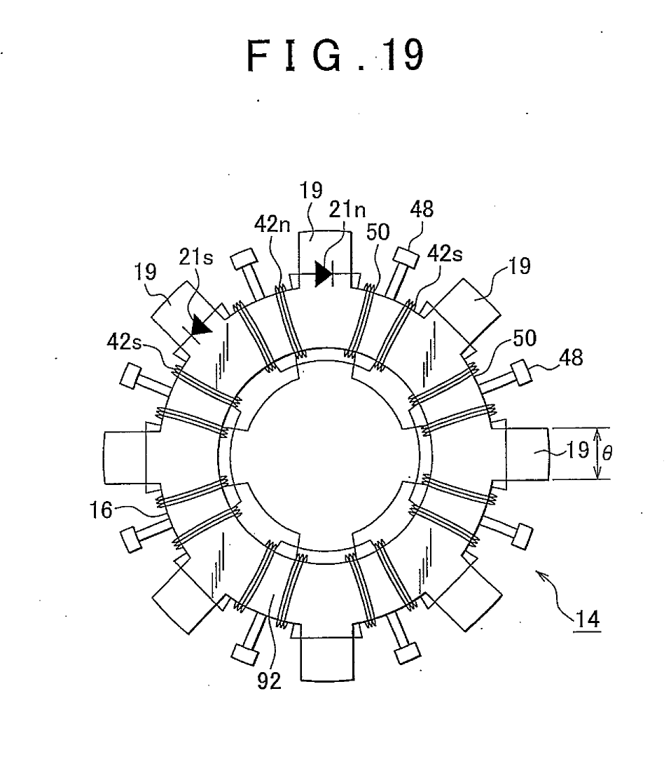

Besides, the rotor windings 42n and 42s can also be provided by a toroidal winding method as shown in FIG. 19. In a construction example shown in FIG. 19, the rotor core 16 includes an annular core portion 92, and teeth 19 that are rotor teeth are protruded radially outward (toward the stator 12) from the annular core portion 92. Besides, in the rotor core 16, a plurality of auxiliary poles 48 each of which is made at least partially of a magnetic material are provided between adjacent teeth 19, that is, each auxiliary pole 48 is provided on a central portion of the bottom of a slot 50 between two adjacent teeth 19 in the circumferential direction of the rotor 14.

Besides, the rotor windings 42n and 42s are wound around the annular core portion 92, at positions near the individual teeth 19, by the toroidal winding method. In the construction example shown in FIG. 19, too, as the rotating magnetic field that is formed by the stator 12 and that includes spatial harmonic components links with the rotor windings 42n and 42s, the direct electric currents rectified by the diodes 21n and 21s flow through the rotor windings 42n and 42s, so that the teeth 19 are magnetized. As a result, the teeth 19 positioned near the rotor windings 42n function as N poles, and the teeth 19 positioned near the rotor windings 42s function as S poles. In that case, by setting the width θ of each tooth 19 in the circumferential direction of the rotor 14 shorter than the width that corresponds to 180° in the electrical angle of the rotor 14, the induced electromotive force produced in the rotor windings 42n and 42s by the spatial harmonics can be efficiently increased. Furthermore, in order to maximize the induced electromotive force produced in the rotor windings 42n and 42s by spatial harmonics, it is preferable that the width θ of each tooth 19 in the circumferential direction be set equal (or substantially equal) to the width that corresponds to 90° in the electrical angle of the rotor 14. Incidentally, in the example shown in FIG. 19, similar to the construction example shown in FIG. 1, the rotor windings 42n and the rotor windings 42s that are alternately adjacent to each other in the circumferential direction are electrically separated from each other; the rotor windings 42n alternately disposed in the circumferential direction are electrically interconnected in series; the rotor windings 42s alternately disposed in the circumferential direction are electrically interconnected in series. However, in the example in which the rotor windings 42n and 42s are wound by the toroidal winding method, too, the rotor windings 42n and the rotor windings 42s that are wound near the teeth 19 may be electrically separated from each other, as in the construction example shown in FIG. 18. Other constructions are the same as those of the foregoing embodiments.

Besides, in the foregoing embodiments, all the teeth 19 may be provided with rotor windings 42 that are electrically interconnected as a single winding wire, for example, as shown in FIG. 20. In the construction example shown in FIG. 20, the rotor windings 42 are short-circuited through a diode 21, so that the current that flows through the rotor windings 42 is rectified into one direction (direct current) by the diode 21. As for the rotor windings 42 wound around the teeth 19, the winding directions of the windings around two teeth 19 adjacent to each other in the circumferential direction are opposite to each other so that the magnetization directions of two teeth 19 adjacent to each other in the circumferential direction are opposite to each other. Besides, in the rotor core 16, a plurality of auxiliary poles 48 each of which is made at least partially of a magnetic material are provided between adjacent teeth 19, that is, each auxiliary pole 48 is provided on a central portion of the bottom of a slot 50 between two adjacent teeth 19 in the circumferential direction of the rotor 14.

In the construction example shown in FIG. 20, with regard to the rotating magnetic field formed on the stator 12, by superimposing the pulse current, for example, on the d-axis command regarding the stator current, the varying magnetic flux links with the rotor windings 42, so that the direct electric current rectified by the diode 21 flows through the rotor windings 42, and the teeth 19 are magnetized. As a result the teeth 19 function as magnets whose magnetic poles are fixed. In that case, two teeth 19 adjacent to each other in the circumferential direction become magnets whose magnetic poles are different from each other. According to the construction example shown in FIG. 20, the number of diodes 21 can be reduced to one. Other constructions are substantially the same as in the above-described embodiment shown in FIGS. 1 to 3.

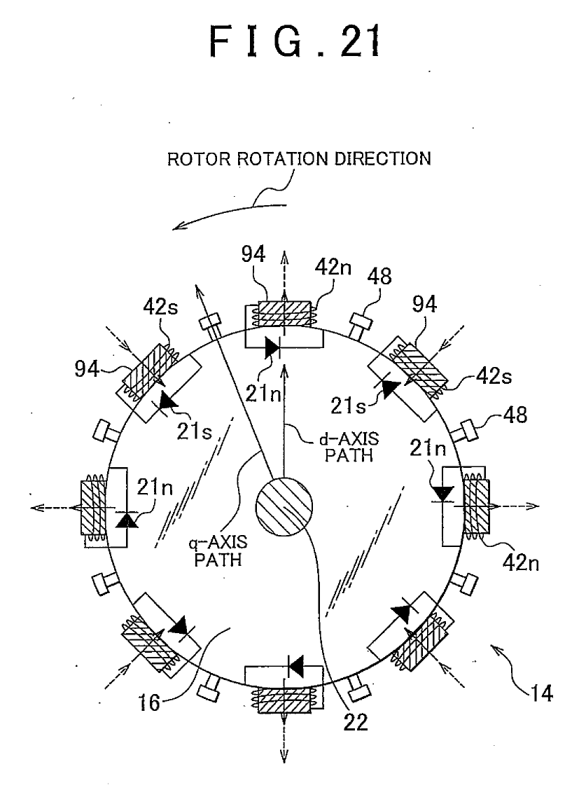

As still another embodiment, rotor windings 42n and 42s may also be wound around permanent magnets 94 that are fixed to a plurality of sites on an outer circumferential surface of the rotor core 16, as shown in FIG. 21. In the rotor 14 that is a component of the rotary electric machine of this construction example, the rotor core 16 has no magnetic saliency, and the permanent magnets 94 are fixed to a plurality of sites on an outer circumferential surface of the rotor core 16 in the circumferential direction of the rotor core 16. Besides, the rotor windings 42n and 42s are wound around the permanent magnets 94. In this construction, portions of the rotor 14 at a plurality of sites in the circumferential direction which coincide with the insides of the rotor windings 42n and 42s with respect to the circumferential direction serve as magnetic pole portions. The permanent magnets 94 are magnetized in radial directions of the rotor 14, and the magnetization directions of two permanent magnets 94 adjacent to each other in the circumferential direction are set opposite to each other in the radial directions. In FIG. 21, solid-line arrows drawn on the permanent magnets 94 represent the magnetization directions of the permanent magnets 94. Besides, a plurality of auxiliary poles 48 that are made at least partially of a magnetic material are provided between adjacent teeth 19, that is, an auxiliary pole 48 is provided on a central portion between each pair of adjacent teeth 19 in the circumferential direction of the rotor 14. The diodes 21n and 21s make alternately different in the circumferential direction of the rotor the magnetic characteristics that are caused to occur inside the rotor windings 42n and 42s by the induced electromotive forces that occur in the rotor windings 42n and 42s.

Besides, the rotor windings 42n and 42s wound around the permanent magnets 94 are not electrically interconnected but are electrically separated (insulated) from each other. The rotor windings 42n and 42s electrically separated from each other are individually short-circuited through diodes 21n and 21s, respectively. The polarity of the diodes 21n and the polarity of the diodes 21s are different from each other. Other constructions are substantially the same as those of the above-described embodiment shown in FIGS. 1 to 3.

While the forms for carrying out the invention have been described above, it should be apparent that such embodiments and the like do not limit the invention at all, but that the invention can be carried out in various forms without departing from the gist of the invention. For example, although in the foregoing description, the rotor is disposed radially inwardly of the stator so that the rotor and the stator face each other, the invention can also be carried out in a construction in which the rotor is disposed radially outwardly of the stator so that the rotor and the stator face each other. Besides, although in the foregoing description, the stator windings are wound around the stator by the concentrated winding method, the invention can also be carried out in, for example, a construction in which stator windings are provided on a stator by a distributed winding method if a rotating magnetic field that has spatial harmonics can be produced. Besides, although in each of the embodiments, the magnetic characteristic adjustment portion is an arrangement of diodes, any other construction can also be adopted as the magnetic characteristic adjustment portion as long as the construction has the function of varying the magnetic characteristics that occur in the rotor teeth or inside the rotor windings alternately in the circumferential direction.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

1. A rotary electric machine comprising:
a stator includes:
a stator core;
stator teeth disposed at a plurality of locations on the stator core that are spaced from each other in a circumferential direction of the stator; and
a plurality of stator windings wound around at least one of the stator core and the stator teeth; and
a rotor that is disposed so as to face the stator and that includes:
a rotor core;
rotor teeth disposed at a plurality of locations on the rotor core that are spaced from each other in a circumferential direction of the rotor;
a plurality of rotor windings wound around at least one of the rotor core and the rotor teeth;
a magnetic auxiliary pole disposed between adjacent two of the rotor teeth that are adjacent to each other in the circumferential direction of the rotor; and
a magnetic characteristic adjustment portion that causes a magnetic characteristic that occurs inside the rotor windings or in the plurality of rotor teeth by induced electromotive force produced in the rotor windings to vary in the circumferential direction of the rotor core.

2. The rotary electric machine according to claim 1, wherein:
the auxiliary pole is protruded from the rotor core toward the stator; and
the auxiliary pole includes a distal end portion that is magnetic and a base portion that is nonmagnetic.

3. The rotary electric machine according to claim 1, wherein:
the auxiliary pole is protruded from an outer circumferential surface of the rotor core toward the stator; and
the auxiliary pole includes a base portion and a distal end portion that has a thickness in the circumferential direction of the rotor that is larger than a thickness of the base portion in the circumferential direction of the rotor.

4. The rotary electric machine according to claim 3, wherein
the base portion and the distal end portion are joined via a stepped portion.

5. The rotary electric machine according to claim 1, wherein:
the rotor windings are connected to rectifying elements, each of which is the magnetic characteristic adjustment portion, in such a manner that forward directions of the rectifying elements in two of the rotor windings that are adjacent to each other in the circumferential direction of the rotor are opposite to each other; and
the rectifying elements are configured so as to cause phases of electric currents that flow through the rotor windings adjacent to each other in the circumferential direction to be different from each other so as to alternate between an A-phase and a B-phase, by rectifying currents that flow through the rotor windings due to production of the induced electromotive force.

6. The rotary electric machine according to claim 1, wherein
a width of each of the rotor windings in the circumferential direction of the rotor is less than a width that corresponds to 180° in electrical angle.

7. The rotary electric machine according to claim 6, wherein
the width of each of the rotor windings in the circumferential direction of the rotor is equal to a width that corresponds to 90° in the electrical angle.

8. A rotary electric machine drive system comprising:
the rotary electric machine according to claim 1;
a drive portion that drives the rotary electric machine; and
a control portion that controls the drive portion, wherein
the control portion includes a decreasing pulse superimposition device configured to superimpose a decreasing pulse current that has a decrease in a pulse fashion on a q-axis current command for causing current to flow through the stator windings so as to produce field magnetic fluxes in directions that are advanced 90° in the electrical angle from magnetic pole directions that are directions of winding center axes of the rotor windings.

9. A rotary electric machine drive system comprising:
the rotary electric machine according to claim 1;
a drive portion that drives the rotary electric machine; and
a control portion that controls the drive portion, wherein
the control portion includes a decreasing/increasing pulse superimposition device configured to superimpose a decreasing pulse current that has a decrease in a pulse fashion on a q-axis current command for causing current to flow through the stator windings so as to produce field magnetic fluxes in directions that are advanced 90° in the electrical angle from magnetic pole directions that are the directions of winding center axes of the rotor windings, and configured to superimpose an increasing pulse current that has an increase in the pulse fashion on a d-axis current command for causing current to flow through the stator windings so as to produce field magnetic fluxes in the magnetic pole directions.
